(19) United States
(12) Patent Application Publication
(10) Pub. No.: US 2013/0246010 A1
(43) Pub. Date: Sep. 19, 2013

(54) System and Method for Optimized Automated Layout of Solar Panels

(71) Applicants: Michael Dershowitz, Bryn Mawr, PA (US); Kevin Ilsen, Bryn Mawr, PA (US); Randy J. Zauhar, Philadelphia, PA (US)

(72) Inventors: Michael Dershowitz, Bryn Mawr, PA (US); Kevin Ilsen, Bryn Mawr, PA (US); Randy J. Zauhar, Philadelphia, PA (US)

(73) Assignee: MODSOLAR, LLC, Bryn Mawr, PA (US)

(21) Appl. No.: 13/611,338

(22) Filed: Sep. 12, 2012

Related U.S. Application Data
(60) Provisional application No. 61/533,356, filed on Sep. 12, 2011.

(51) Int. Cl. G06F 17/50

(52) U.S. Cl. CPC G06F 17/50
USPC 703/1

(57) ABSTRACT

The present invention provides an automated system and method for laying out photovoltaic (PV) solar panels on one or more regions of a roof or ground installation. Automation includes a presentation of optimal comparative layouts, use of different panels (of the same or different manufacturers), and consideration of different energy production characteristics and different layout constraints. Diverse mathematical approaches are used to determine the optimal panel layout for a given geographic region and for particular goals, including, but not limited to, the objective of maximizing the solar production from the designated region(s). The application of two such mathematical algorithms are detailed as parts of an exemplary embodiment: a deterministic edge-aligned approach as well as a nondeterministic approach that employs a genetic evolution simulation.

### CROSS REFERENCE TO RELATED APPLICATION

This utility application claims the priority and benefit of U.S. Provisional Patent Application Ser. No. 61/533,356, entitled “System and Method for Optimized Automated Layout of Solar Panels,” filed Sep. 12, 2011, the entirety of which is incorporated herein by reference.

### FIELD OF INVENTION

The present invention relates to methods, systems, and encoded computer readable mediums including electrical computers and data processing systems applied to automating the layout of individual solar photovoltaic (“PV”) panels on a roof or ground property in order to form a solar energy collection and electrical production system. In particular, the invention is concerned with optimizing the layout according to a desired individual or compound goal, and presenting optimal layouts for different manufacturers' panels and different layout options, in a format that facilitates easy comparison and final selection of a particular derived layout for a particular panel make and model.

### BACKGROUND OF THE INVENTION

Solar power (in either photonic or thermal form) has been in use in the United States for decades for niche applications or by hobbyists. Solar thermal applications have been used in remote locations to primarily heat water for domestic uses. The US Space Program was one of the first major consumers of photonic solar power, semiconductors or solar photovoltaic (“PV”) cells, which could convert the sun's light energy into electrons, in the form of direct current (DC) electricity. Most early satellites used solar panels in some form to provide electricity to the devices aboard a satellite, and this is still the case today.

Since the 1970s, the industry has evolved to create additional applications and to work toward making solar power viable in areas of the earth where electricity was needed but a power grid did not reach. In the mid-1990s, the industry reached a point where the cost of producing solar panels (or modules, as they're sometimes called) was low enough that they could also be used in areas with grid connectivity, but where grid power was still very expensive. As grid connectivity for solar expanded, and the solar industry along with it, the price of solar modules continued to drop, and many additional applications became possible, including residential systems, as well as large-scale utility systems, which provide large amounts of power into the grid as an energy generation source for consumption by end users. Such applications require that the DC electricity produced by the solar panels be converted to alternating current (AC) electricity. The DC-to-AC conversion process involves a predictable loss of energy.

The actual AC power production of solar panels depends on a variety of factors that can impact the amount of sun exposure that the panels receive. Examples of such factors include (but are not limited to) the geographic location (notably the latitude), the installation angle of the panels (relative to the ground plane), and the direction that the panels are facing. Other examples include factors unique to the site itself, such as shadows cast by nearby trees or buildings, or roof-mounted objects such as chimneys or air conditioning equipment.

The solar industry has steadily progressed in its ability to predict the “real-world” energy production of a solar system, prior to its actual installation, by taking into consideration the various factors noted above. Such predictability is an important step in the pre-purchase cost/benefit analysis: an estimate of a solar system's production—and hence the cost savings that will be realized after installation—affects the decision of whether to purchase and install the system. And in order to create an accurate estimate, the actual solar system must be designed—including the specific placement of individual panels on the ground or roof surface(s).

From the early days of the industry through the last decade, each solar PV system was designed by hand, using whatever were the prevalent methods for structural and electrical engineering design at the time the system was installed. Typically the designs were hand-drawn diagrams produced by professional electrical engineers and draftsmen. The “sizing” of a PV system (determining how much power could be produced from a given area where the solar modules were to be placed) was a major qualification step of getting a solar project off the ground, and would take days or weeks to complete, depending on the scope of the system being envisioned. Most systems would require both an electrical system diagram as well as a typical structural diagram for structural engineering or land planning uses. In most permitting jurisdictions around the country, both diagrams (electrical as well as structural) are required in order to obtain a building permit to build a solar PV system, and a building permit is required in virtually all cases. Abstractions of physical spaces drawn into the structural diagrams were used as the basis of where to put the solar panels. Satellite imagery had not yet been introduced outside of a military context for public use in the construction industry.

The rise of computer aided design (CAD) in the late 1980s and 1990s moved the industry, in most cases, away from hand-drawn diagrams and into a more streamlined process that allowed for easier editing of drawings, and thus more iterations. Initially, these CAD tools were crude, but the time required to edit was about half what hand-drawn diagrams would require. As the CAD software itself became more sophisticated, the time for editing drawings continued to decrease. However, CAD still suffered from a host of limitations, most prominently relying on abstractions of physical objects, whether it be an area of land or a building, when deciding where to put the solar panels, as well as the inability to compare equipment for use in a particular project, thus leading to suboptimal equipment choices for a given area. Precision derived from being able to measure exact physical spaces on the earth from satellite imagery was still a decade away.

As the industry continued to scale, and as the cost of solar continued to drop in the late 1990s and early 2000s, the cost of producing full engineering diagrams via CAD was becoming prohibitive, and the industry began to search for other tools that could speed up the design process. Several tools emerged in the early 2000s to address this problem, integrating the CAD drawing software the industry had become used to, but extending it to layer in additional information and intelligence needed to design a solar PV system. While a major step forward, such tools still had 3 major limitations: (1) users of these tools were still designing a system on an abstraction of an actual physical location or building on the earth; (2) these tools still relied upon the user to know and confirm that the spatial measurements they were using were correct; and (3) the user was unable to compare different solar modules to determine which would be the optimal choice for a given space.

Although they improved the efficiency of the design process, these tools were never intended to address the financial aspects of constructing a solar PV system. As the sales of solar PV systems became hugely important for the industry in order to achieve the scale that market conditions were demanding, new tools emerged to handle the financial aspects of solar PV systems, taking into account energy savings, financial incentives from various governmental and utility institutions, as well as the cost of materials. Calculation tools emerged—including a service known as “PVWATTS” still offered by the United States government's National Renewable Energy Laboratory—to predict the AC power production of a given solar panel “array” (an installed group of solar panels oriented in the same direction, at the same angle, etc.). The major limitation with these new tools was their reliance on the user to know the system design before quoting could occur.

In 2008, a tool called RoofRay emerged that took advantage of the rising sophistication of satellite imagery made available by Google, Microsoft, and others. RoofRay combined satellite imagery with interactive measuring tools based on that imagery, to give its users the ability to calculate square footage on a particular area somewhere on the earth (for example, a particular roof surface). It then took that measurement and made a rough approximation of the potential AC energy that could be produced if that entire area were covered 100% with solar cells, and consequently calculated the cost savings to the consumer based on using that energy instead of purchasing it from the power grid. Although this approach broke the “abstraction” problem by allowing the user to specify and measure areas on satellite imagery, the calculations were far too approximate—and therefore inaccurate—to be practical.

Other design tools have also emerged that offer users the ability to manually place panels on the ground or on a roof surface rendered using satellite imagery. But such tools lack the integrated calculation of energy production—an essential piece of input to the cost/benefit analysis. And none of these tools offers a convenient way to compare different layouts produced using different manufacturers' panels or different goals for the array (such as maximizing energy production).

Consequently, the industry continues to suffer in that the tools available form an artificial barrier between system design and financial estimation with sufficient accuracy. While many of the abstracted design tools do a good job of representing a solar panel layout that a user desires, they lack the real-world interface. The cost/benefit analysis tools are most concerned with the accuracy of their financial data, and assume their users will get the system design right, or use another tool to do a system design. Prior to this invention, no tool existed in the industry that provided sufficiently accurate module layout, coupled with power production estimation. Besides the integration problem existing in the industry, no design tool in the industry streamlined the process of designing a solar system by providing an automated and accurate means of laying out solar modules in a given space. Nor did any tool in the industry present its user with an on-screen comparison of different layouts based on the use of different modules or different options/constraints, ultimately allowing the user to select a module and layout that optimally achieved a desired goal, such as producing the most power from the space given.

### BRIEF SUMMARY OF THE INVENTION

Recognizing the need to provide a convenient yet accurate way to facilitate the optimal layout of ground- or roof-mounted solar panels, the present invention provides systems and methods for automated layout of solar panels within designated regions, optimized to achieve one or more specific goals of an installation, and offering a user the ability to designate options, parameter values and constraints that impact the underlying layout algorithm(s), as well as the ability to compare the panel layouts that are the result of the application of those algorithms.

Different algorithms may be employed, depending on the specific goals of the installation as determined by the solar system's installer/designer and/or its prospective buyer. Layouts are automatically produced and can be regenerated easily with different options. Layout metrics are displayed side-by-side and sorted according to the goal being sought (for example, maximum power production), and any individual layout can be viewed overlaid on satellite imagery of the installation location.

The combination of automated layout (filling designated regions with solar panels), integrated prediction of generated solar power based on actual panel placement details, and direct comparison of resultant layouts and power production in a single design tool, represents a unique solution to a long-standing problem in the solar industry. The application of varying mathematical algorithms to the task of producing the layout automatically, and in particular the application of an algorithm that simulates an evolution of a group of solutions for the optimized arrangement of solar panels, is based on use of the genetic evolution algorithm to consider and optimize variables.

The present invention also provides a computer readable medium encoded with instructions for a program configured for execution by the interactive layout process controller to perform the methods of the invention.

The present invention overcomes significant industry problems related to inaccurate calculations related to the cost/benefit of solar panel installations.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Additional aspects, features and advantages of the invention, as to its structure, functionality, and use, will be understood and become more readily apparent when the invention is considered in light of the following description of illustrative embodiments made in conjunction with the accompanying drawings, wherein:

FIG. 1 shows a block diagram of a generic embodiment of the invention.

FIG. 2 shows a schematic block diagram of an indicative hardware platform supporting the embodiment of FIG. 1.

FIG. 3 shows a schematic block diagram of an alternate hardware platform supporting the embodiment of FIG. 1.

FIG. 4 shows a block diagram of an exemplary system in which the invention has been embodied.

FIG. 5 shows a block diagram of the layered architecture of a Java-based embodiment of the invention.

FIG. 6 shows a screen capture of the layout view page in the exemplary embodiment.

FIG. 7 shows a partial screen capture of the user specification of the mount type on the layout view page in the exemplary embodiment.

FIG. 8 shows a partial screen capture of the user specification of the mount type on the layout view page in the exemplary embodiment.

FIG. 9 shows a partial screen capture of the user specification of the mount type on the layout view page in the exemplary embodiment.

FIG. 10 shows a partial screen capture of the user specification of the panel orientation on the layout view page in the exemplary embodiment.

FIGS. 11A and 11B illustrate a portrait orientation of panels on a sloped roof.

FIGS. 12A and 12B illustrate a landscape orientation of panels on a sloped roof.

FIGS. 13A and 13B illustrate a portrait orientation of panels on a flat roof or ground installation.

FIGS. 14A and 14B illustrate a landscape orientation of panels on a flat roof or ground installation.

FIG. 15 shows a partial screen capture of the user specification of the panel spacing on the layout view page in the exemplary embodiment.

FIG. 16 shows a screen capture of an administrator page in the exemplary embodiment, permitting the specification of default panel spacing.

FIG. 17 shows a screen capture of the layout view page in the exemplary embodiment, showing alternate options having been supplied to the layout algorithm.

FIGS. 18-19 show partial screen captures of the layout view page in the exemplary embodiment, illustrating the automatic initiation and asynchronous completion of the layout algorithms.

FIGS. 20-22 show screen captures of the layout view page in the exemplary embodiment, illustrating different panel layout solutions resulting from application of the algorithms.

FIGS. 23-26 show partial screen captures of the layout view page in the exemplary embodiment, illustrating the process of deleting panels from a layout solution.

FIG. 27 shows a screen capture of the layout view page in the exemplary embodiment, illustrating the effect of the “See-through panels” option.

FIG. 28 illustrates certain concepts and terminology used in the exemplary layout algorithms, regarding layout line objects.

FIG. 29 illustrates certain concepts and terminology used in the exemplary layout algorithms, regarding occluded intervals.

FIG. 30 illustrates certain concepts and terminology used in the exemplary layout algorithms, regarding the definition of a single span from a collection of occluded intervals.

FIG. 31 is an illustration of the geometry of a deterministic algorithm.

FIG. 32 is an illustration of the geometry of a non-deterministic (genetic evolution simulation) algorithm.

FIG. 33 is a graphical representation of the mating between two parent chromosomes that represent variables of panel layout characteristics, to yield a progeny chromosome that blends the traits of the parents.

### DETAILED DESCRIPTION OF EMBODIMENTS OF THE INVENTION

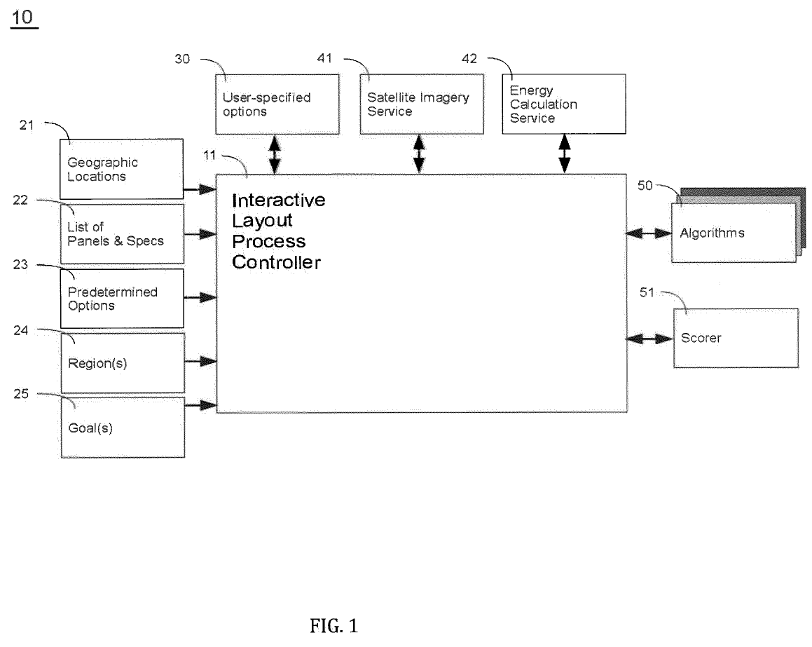

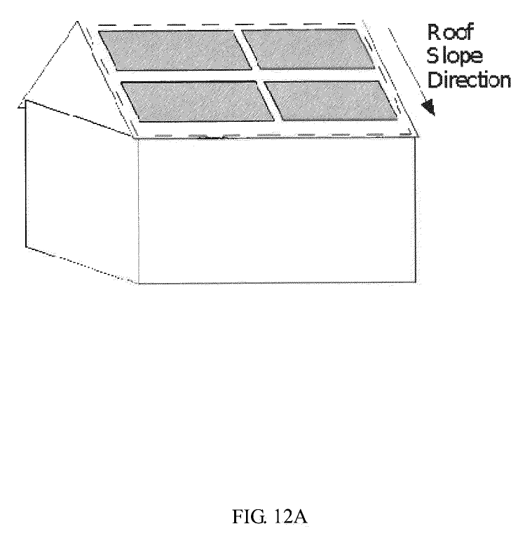

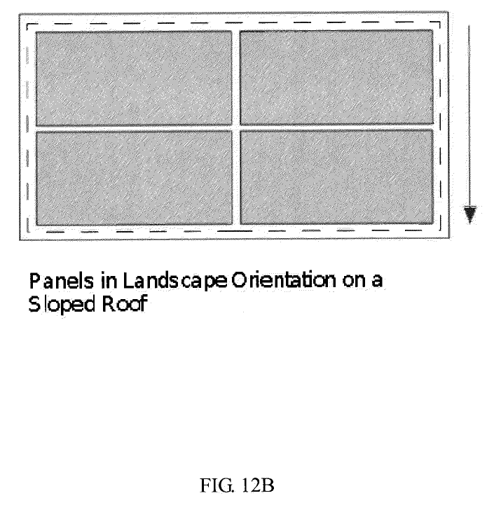

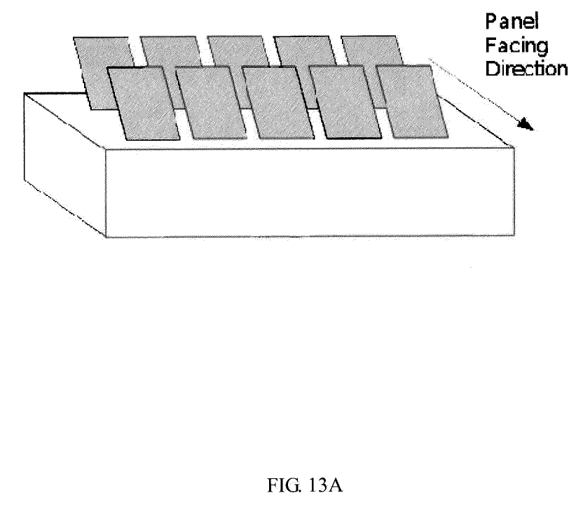

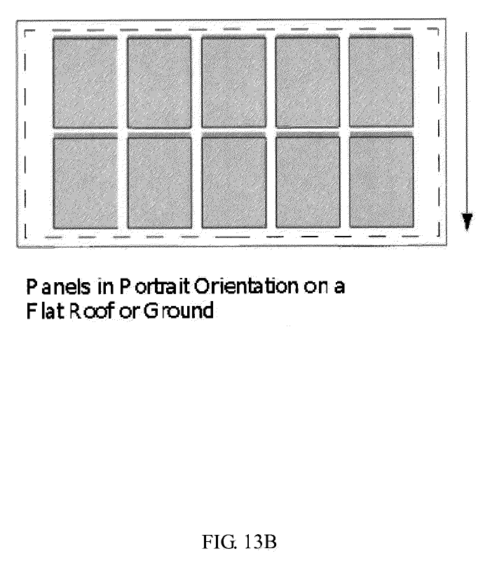

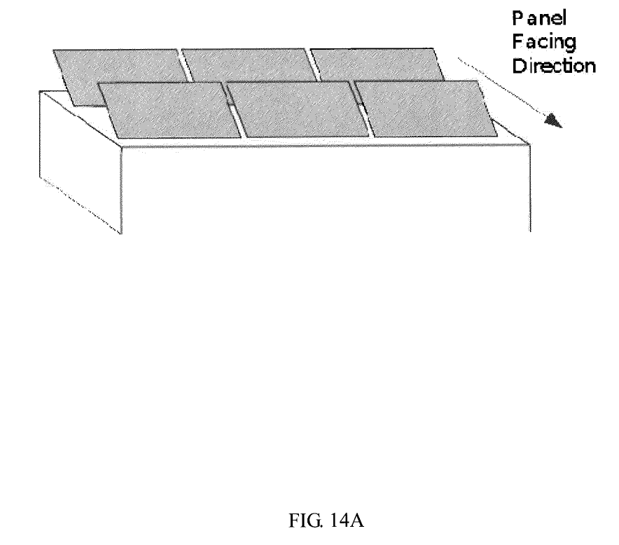

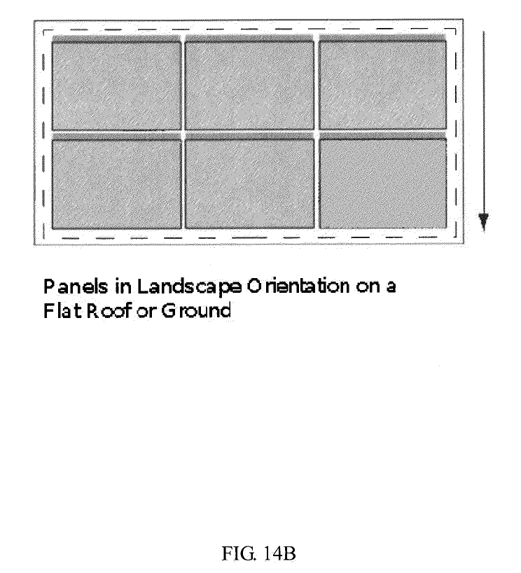

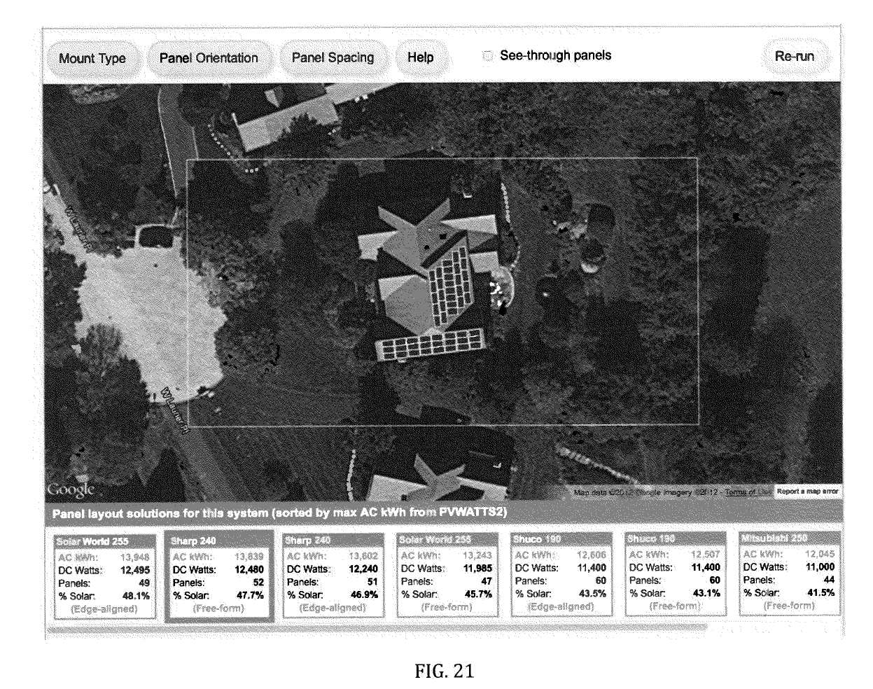

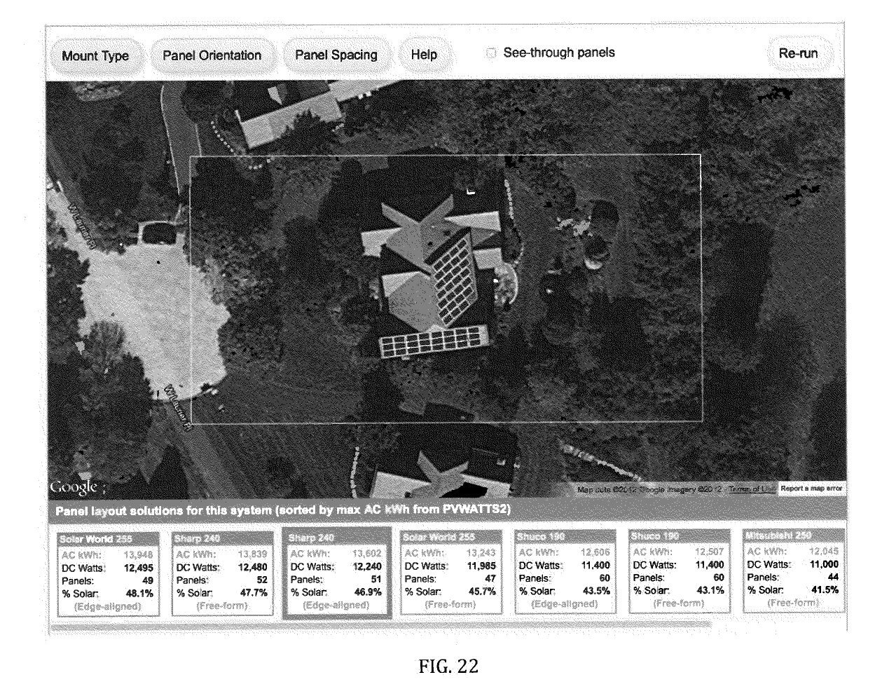

Illustrative and alternative embodiments of the invention will be discussed in detail, as follows, with reference to FIGS. 1-33 provided with this application. The embodiments are provided to illustrate aspects of the invention, but the invention is not limited by any embodiment. The scope of the invention encompasses numerous alternatives, modifications, and equivalents.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The description first discusses the hardware and software context in which the invention can be embodied. This is followed by an overview of the major components of the invention, how they inter-relate with one another, and how they relate to the surrounding system in which they have been embodied. Finally, each component is described in detail, including the reduction to practice of specific algorithms that are part of the exemplary embodiments of the invention.

Generally, the invention may be operated on a computer system having one or more computers, each with processor circuitry, memory, and a data storage system linked to the processor circuitry. Software code related to the operation of the system and method may be stored on and retrieved from the memory and/or the data storage system. The computer system may be embedded or otherwise, including but not limited to PCs, workstations, servers, wireless and wired telecommunication processor systems, mainframes, and the like. The operating system may be PC, Apple, or other operating system or variety of operating systems including, but not limited to, HP-UX, LINUX, UNIX, Microsoft, NT, AIX, OSX, or the like. The computer system may be embedded in a PDA, a smartphone, a desktop computer, a notebook, a smartphone, a tablet, an application specific embedded device/instrument, or the like. The computer readable medium may comprise memory within processor circuitry or in other devices and includes, for example, cache memory, RAM, local memory storage devices like a hard disk drive, flash drive, or any other medium that is or can be connected to and/or operated by processor circuitry. In an embodiment, the computer system of the invention comprises one computer. In an alternative embodiment, the computer system comprises two or more computers that communicate with one another by wired or wireless Internet or other connections.

System Context

FIG. 1 shows a block diagram of a generic embodiment of the invention (10). Central to the embodiment is a main interactive layout process controller (11) that accepts a variety of inputs (21, 22, 23, 24, 25) and allows for user interaction (30) to modify options that alter the behavior of the process controller. Subsystems are employed to render the satellite (also “aerial”) imagery (41) and calculate the energy production (42), as well as to apply the layout algorithm(s) (50) and to “score” the results (51) according to how well they achieve the desired goal(s).

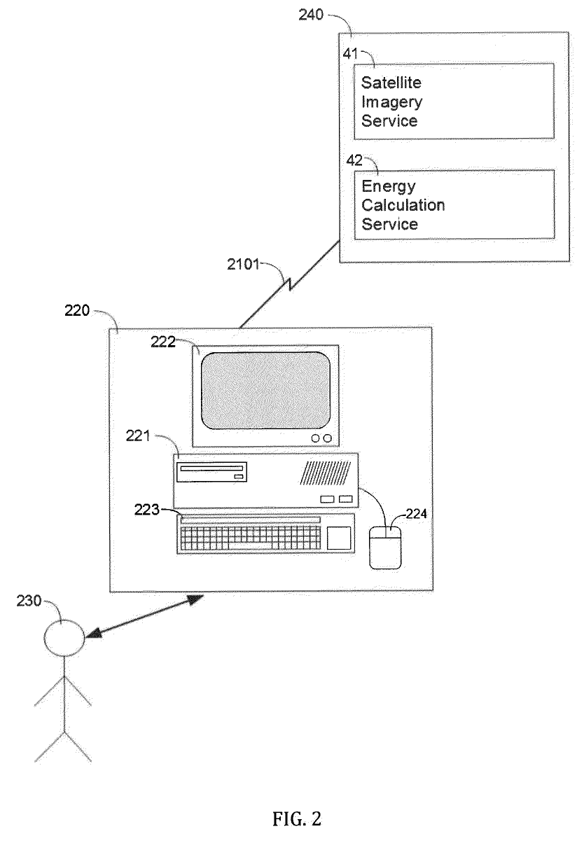

FIG. 2 shows an embodiment of a computer system for the invention (10). A single computer (220) with a processing unit (221), display (222), keyboard (223), and mouse or other pointing device (224) is used, with which a user (230) interacts. The computer (220) uses an Internet connection (2101) to connect to the Internet and communicate with separate computer devices consisting of combinations of hardware and software that provide the functionality for rendering satellite imagery (41) and calculating the energy production (42). For example, the computer (220) communicates with the separate computer devices through a web interface available at www.modsolar.net. The computer (220) implements the remainder of the functionality illustrated in the block diagram of FIG. 1.

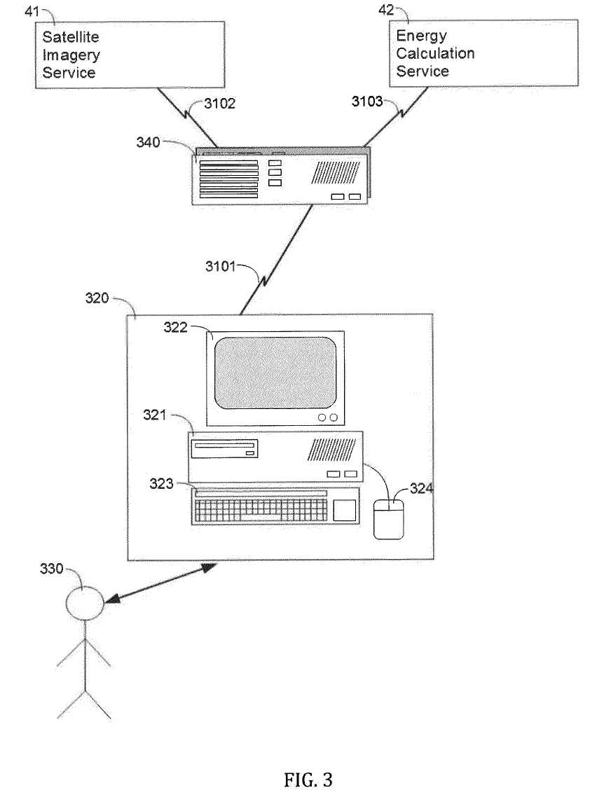

FIG. 3 shows an alternate embodiment of a computer system for the invention (10) detailed generally in FIG. 1. A single computer (320) with a processing unit (321), display device (322), keyboard or other text input device (323), and mouse or other pointing device (324) is used, with which a user (330) interacts. The computer (320) may be any one of a desktop or laptop computer, a PDA, a smartphone, a notebook, a tablet or the like, or similar computer system. The computer (320) uses an Internet connection (3101) to connect to a server computer (340). The server computer (340) and the user's computer (320) interact in such way that the server computer (340) directs the user's computer (320) to display information to the user, and the user's computer (320) collects information from the user (330) and transmits it to the server computer (340). The server computer (340) uses Internet connections (3102, 3103) to connect to the Internet and communicate with separate computer devices consisting of combinations of hardware and software that provide the functionality for rendering satellite imagery (41) and calculating the energy production (42). The server computer (340) and/or the user's computer (320) implement the remainder of the functionality illustrated in the block diagram of FIG. 1.

In an alternative embodiment of the present invention, the computer (20) implements all of the functionality illustrated in the block diagram of FIG. 1.

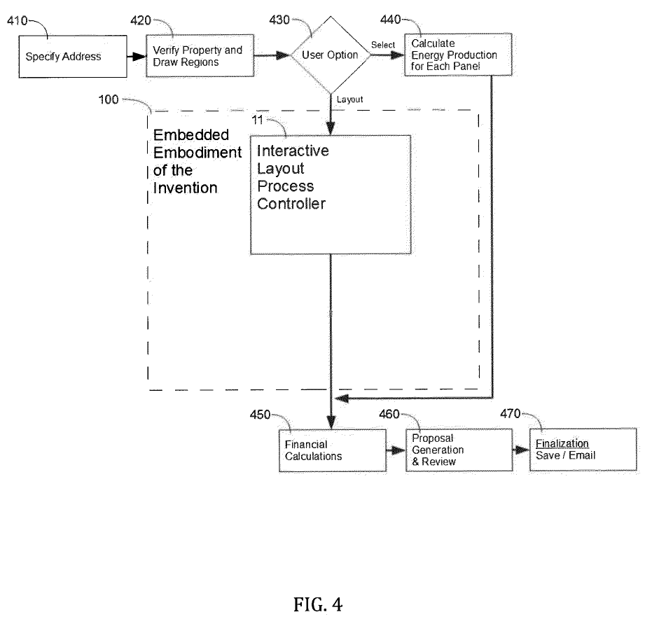

FIG. 4 shows a block diagram of a general system for developing the layout of a solar panel array. Specifically, a user of the system (employed by a solar installation contractor, an engineering procurement and construction firm, a solar industry products manufacturer, or similar entity) would specify a property address (410) and then visually verify the property and interactively draw the region(s) where panels should be placed (420). Then the system would perform a rough calculation of energy production for each preferred panel and present the results, based on a simple and imperfect estimate of the number of panels that would fit in the drawn region(s) (440). The user would select a panel and then the system's financial calculation subsystem (450) would present the full cost analysis including application of eligible incentives, allowing the user to adjust costs, line items, select/de-select incentives, etc. Based on the user's input, the proposal generation subsystem (460) would then produce a formatted proposal for the user to review, incorporating the specific details of the selected panel, the solar energy production, the system installation costs, and the financial and environmental benefits achieved. In the final step (470) the user could save the proposal or request that the system email the proposal directly to the user's designated potential buyer of the solar system.

FIG. 4 also illustrates the point at which the present invention (100) has been incorporated within and functions in the general system. The user is given the choice (430) to proceed as before—with imprecise calculations (440)—or to use the new automated layout approach (100) that embodies the present invention.

In the exemplary embodiment, the system depicted in FIG. 4 is implemented as an interactive program accessed by users via the Internet, as illustrated in FIG. 3. The primary computer language used to implement the system as well as the exemplary embodiment of the invention is the Java programming language, running on one of the server computers (340) and utilizing a database management system running on one of the servers computers (340). The Java program communicates with the database management system using the well-known Java DataBase Connectivity (JDBC) protocol, and the characteristics of that protocol make it possible for the Java program and the database management system to be installed on separate servers or to be co-located on the same server. The database management system serves as the storage repository for persistent data, including the specifications of preferred panels (22 in FIG. 1) for each user of the system and each user's predefined options (23 in FIG. 1), and optionally satellite imagery and power production of the panels.

The particular exemplary embodiments of the invention, within a system that is accessible to users via the Internet, adheres to certain standards and patterns of computer program architecture that are known and understood by those skilled in the art of computer software development. Other implementations are certainly possible, using differing architectures and even differing computer software languages. In the interest of clarity, the detailed description of the components is based on the exemplary embodiments of the invention, as well as the architecture of the system context in which it has been embodied.

Overview of Major Components

Referring again to FIG. 1, the invention (10) includes a core interactive layout process controller (11) incorporating process control, user input, and display functionality, whereby a user can see the results of the application of the layout algorithm(s) (50), alter the inputs (30) and re-run the algorithm(s), and ultimately make a selection from the generated layouts. The main layout process controller (11) requires several inputs in order to begin, including the geographic location information (21), the list of preferred solar panels and their specifications (22), a predefined set of default options (23) for the algorithm(s), the region(s) in which panels should be placed (24) and the overall goal(s) being sought (25).

FIG. 1 shows that the interactive layout process controller (11) relies on an external service (41) to display the satellite imagery on which the panel layouts will be overlaid, and makes appropriate requests to that service using the supplied geographic location data (21) as input. In alternative embodiments, the satellite imagery may be retrieved from storage on the data management system. The interactive layout process controller uses the supplied predefined options (23) to invoke one or more of the layout algorithms (50) to produce layouts based on each of the preferred panels (22), in each of the specified regions (24). Depending on the designated goal(s) (25), different algorithms might be selected, and the same panel might be run through the algorithm(s) multiple times, with different operational parameters. For example, with a goal of maximizing energy production, it is important to layout the panels in a way that maximizes their exposure to the sun. All other things being equal, direct southern exposure (for locations in the northern hemisphere) will yield the maximum exposure to the sun. Thus, the interactive layout process controller might invoke an algorithm twice: once using the panel facing direction specified as input to the process, and a second time where the specified panel facing direction is ignored, and instead a due-south direction is used. Depending on the shape of the region in which the panels are being placed, this might yield more energy production (the shape of the region and the orientation of the panels will determine how many panels fit in the region).

Ultimately, the interactive layout process controller (11) will receive multiple panel layouts (also referred to as layout schemes) as shown in FIG. 1 that are the result of applying different layout algorithms, with different options, parameter values, and constraints, using different manufacturers' panels having different characteristics of width, height, and energy production capability. The interactive layout process controller (11) will use a “scoring” subsystem (51) that will rank the resultant layouts according to how well they achieve the desired goal(s) (24).

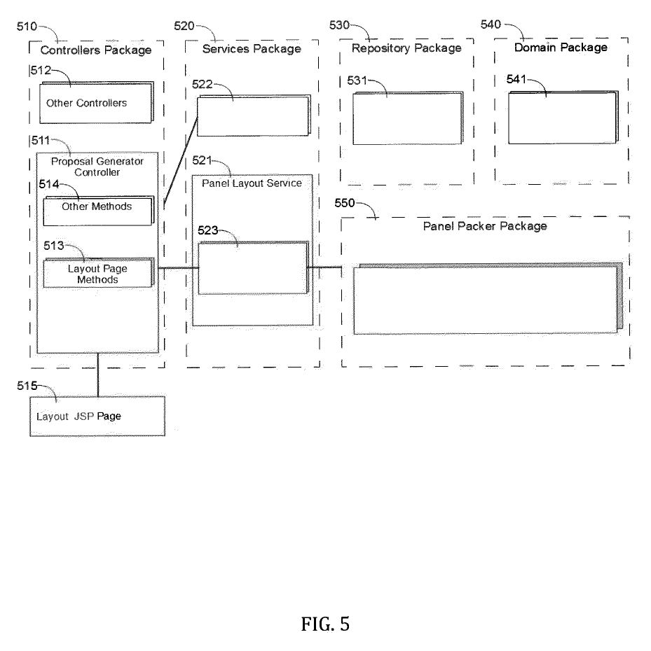

The implementation of the exemplary embodiment adheres to a software architectural design approach for Internet-accessible software programs, known as “MVC” which stands for “model/view/controller.” In this architecture, the portions of the software that are responsible for representing the data structures and object (the “model”), and the presentation of information to the user (the “view”), and the overall control and coordination of the program (the “controller”) are implemented using separate software components. In the exemplary embodiment, the “view” aspects are implemented using Java Server Pages (JSP) technology, together with HyperText Markup Language (HTML), Cascading Style Sheets (CSS), and JavaScript. The “model” and “controller” aspects are implemented in Java. The exemplary embodiment further segments the architecture of the Java code by grouping the Java code classes into packages that represent layers of functionality. FIG. 5 illustrates the layered Java class architecture. For clarity, only the specific classes that implement the invention are specifically labeled in FIG. 5; many other classes are also present, as they implement the system context in which the exemplary embodiment was reduced to practice.

In FIG. 5, a Controllers package (510) includes a Proposal Generator Controller class (511) as well as several other classes (512). Within the Proposal Generator Controller class (511), there are several Java controller methods (513) that interact with a JSP page (515) responsible for user interaction relating to the automated layout. Other classes (514) also exist within the Controllers package, which are part of the system context in which the invention is embodied.

Also in FIG. 5, a Services package (520) includes a Panel Layout Service class (521) as well as several other classes (522) that are part of the system context in which the invention is embodied. The Panel Layout Service class (521) includes a variety of Java service methods (523) that implement different aspects of the invention, under the direction of the methods (513) in the Proposal Generator Controller class (511) that are specific to the invention.

Again in FIG. 5, a Repository package (530) includes several utility classes that interact with the database management system, and a Domain package (540) includes several object classes (541) that comprise the “model” portion of the MVC architecture.

Finally, FIG. 5 includes a Panel Packer package (550), which includes several different Java classes (551) that implement the plurality of layout algorithms.

Goal-Directed Layout Algorithms

The interactive layout process controller (11) depicted in FIG. 1 makes use of one or more sub-components that implement the actual layout algorithms (50). Several input parameters (23, 24, 30) are passed through to the algorithms for processing. The most obvious parameter is of course the specification of the region(s) (24) in which the panels should be arranged. However, other predefined (23) and user-specified (30) options may include such parameters as the panel orientation, the directions the panels should face, and the spacing between panels and between rows. Depending on the desired goal(s) (24), there may be additional parameters that are passed to the algorithms. An example is the restriction that the panels should be laid out in a strict grid pattern of rows and columns in order to be compatible with a particular type of physical mounting system. Furthermore, the goal(s) (24) and the nature of the individual implemented algorithms (50) might dictate that certain algorithms will or will not be used.

As non-limiting examples, and not withstanding any other goals described in this application, the desired goals for a solar panel array may include any one or more of the following: maximization of the number solar panels that can be installed at an installation site, maximization of energy production from the solar panels according to an optimized layout scheme, achievement of cost range for the solar panel array, achievement of a size range for the solar panel array, minimization of layout hardware for the solar panel array, and maximization of tax credits related to an array or installation site.

Each algorithm sub-component (50) produces a layout based on the parameters supplied. The interactive layout process controller (11) uses a scorer (51) to rank the layouts according to how well they achieve the desired goal(s) (24). This scoring might require that additional processing be applied to the resultant layout. In the exemplary embodiment, the primary goal is to maximize the production of AC energy. In order to score against this goal, an energy calculation service (42) is used. In the exemplary embodiment, the service is provided by the PVWatts web service of the U.S. Government National Renewable Energy Laboratory. In an alternative embodiment, the energy calculations may be made from data stored on the data management system. For a given arrangement of panels in a particular orientation, with a particular tilt angle, (both of which having been specified either as predefined options (23) or user-specified options (30)), and at a particular geographic location (21), and based on the specifications of the panels used (22), the PVWatts web service can predict the expected energy production.

User Specification of Options to Algorithms

The interactive layout process controller (11) of FIG. 1 gives the user the ability to specify certain options that control the behavior of the controller itself (11) as well as the algorithms (50) used to generate the layouts. In the exemplary embodiment, a view (the layout JSP page (15) in FIG. 5) is presented in the user's web browser, affording the user the opportunity to see and change the options, and to re-run the algorithms to generate new layouts.

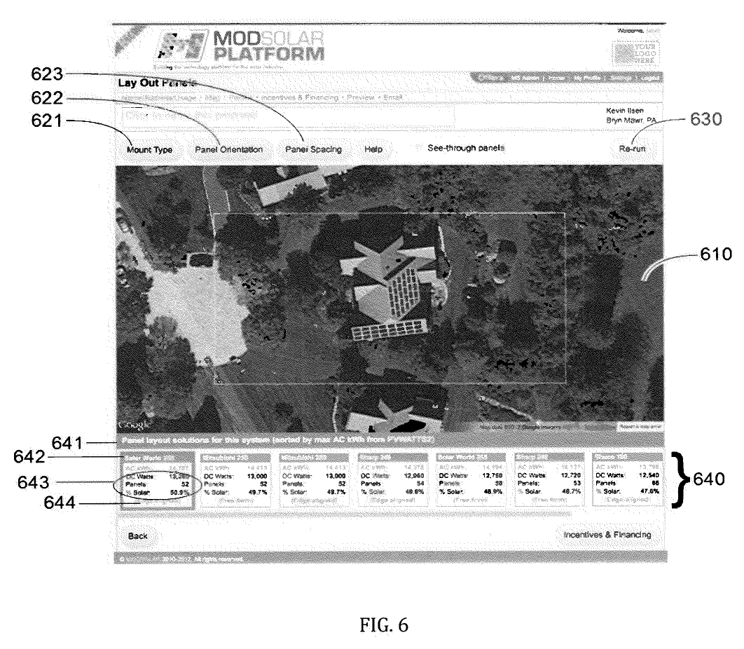

FIG. 6 shows a screen capture of the layout view page in the exemplary embodiment. The bulk of the screen consists of the satellite imagery (10) of the property where the solar panels will be installed. The satellite imagery is provided by a sub-component denoted in FIG. 1 as the satellite imagery service (41). In the exemplary embodiment, that service is provided by Google Maps, although other services could be used without limiting the invention. For example, and in an alternative embodiment, the satellite imagery may be stored on the data management system. In the exemplary embodiment, the same satellite imagery service is used to provide the functionality required to verify the property and draw the region(s)—an existing step (40) depicted in FIG. 4.

Referring again to FIG. 6, several user-clickable buttons (621, 622, 623) permit the user to alter the options, parameters, and constraints that will be used by the interactive layout process controller and/or passed to the algorithm(s). The user may change one, multiple, or all such options, parameters, and constraints, and then click another button (630) to re-run the algorithm(s) to produce the layout(s).

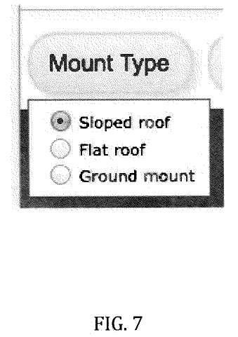

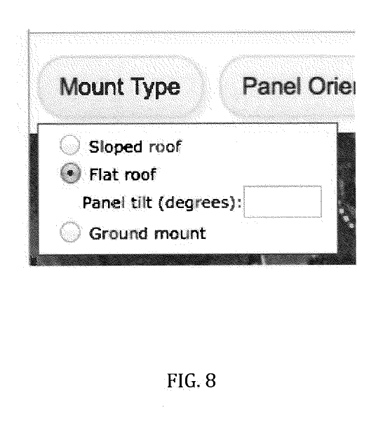

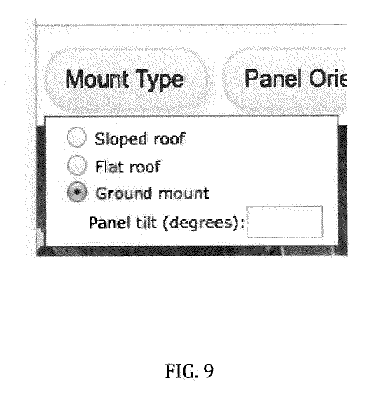

If the user clicks the “Mount Type” button (621), a set of options appears just below the button, as shown in FIG. 7, allowing the user to view and/or change the intended mount type (i.e., whether the solar panels will be installed on a sloped roof, on a flat roof, or on the ground). If the user selects Flat roof or Ground mount, an additional option appears, as illustrated in FIGS. 8 and 9, allowing the user to specify the angle at which the solar panels will be installed. In the case of a sloped roof, the solar panels will be installed flush on the surface of the roof, and the user will have already specified the roof slope, as part of the step of drawing the region(s)—an existing step depicted in FIG. 4 as verify property and draw regions (420).

Referring again to FIGS. 8 and 9, the user has the ability to enter a specific panel tilt angle—for example, 15 degrees, as illustrated in FIG. 8—or to let the layout algorithm use a tilt angle that is automatically set based on the latitude of the property location. In the exemplary embodiment, the user indicates this by leaving the panel tilt angle blank.

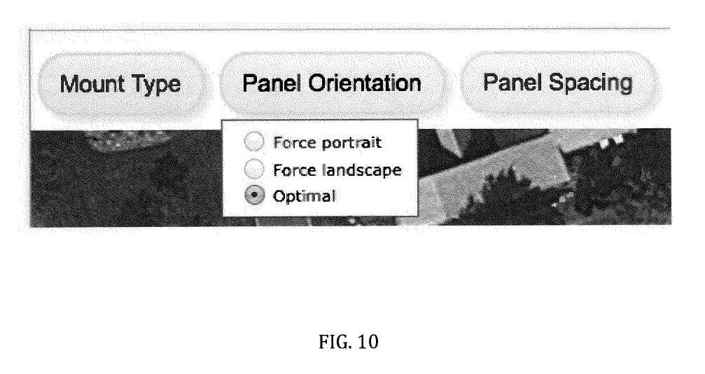

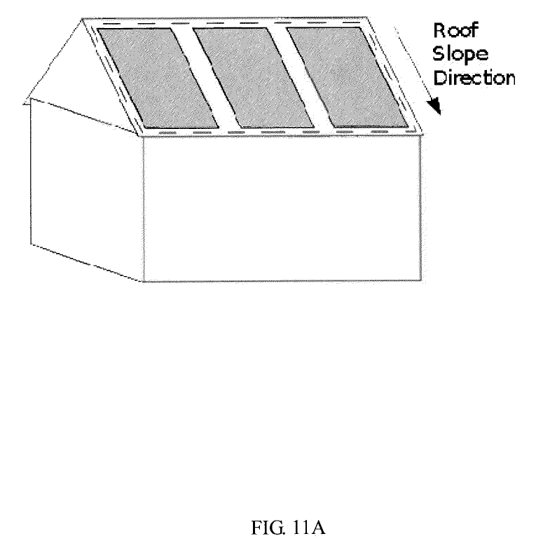

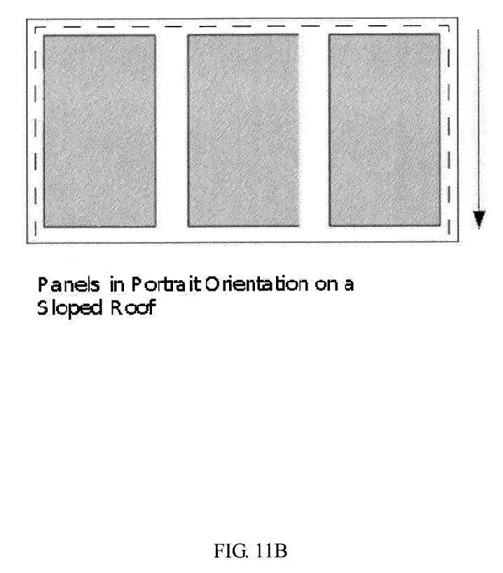

Referring now to FIG. 6, if the user clicks the “Panel Orientation” button (622), a set of options appears just below the button, as shown in FIG. 10, allowing the user to view and/or change the orientation of the panels with respect to the direction that they face. “Force portrait” means that the shortest edge of the solar panel will be positioned perpendicular to the azimuth (the panel facing direction for flat roof and ground mount; the roof slope direction for sloped roof). “Force landscape” means that the longest edge of the solar panel will be positioned perpendicular to the azimuth. “Optimal” means that the layout algorithm will not be constrained as to the panel orientation; the algorithm may choose whether to use portrait or landscape. FIGS. 11a-14b show illustrations of the meaning of portrait and landscape panel orientations for sloped and flat roof/ground mount installations.

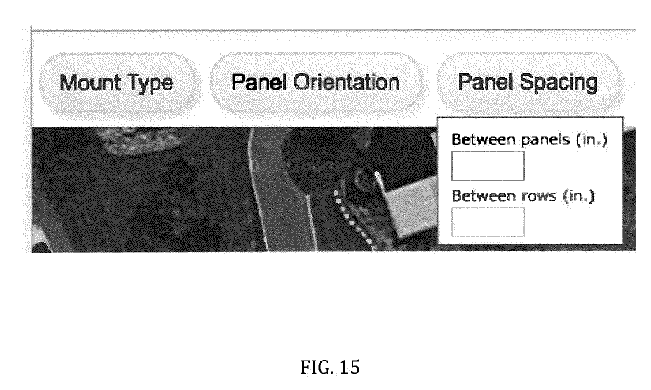

Referring again to FIG. 6, if the user clicks the “Panel Spacing” button (623), a set of options appears just below the button, as shown in FIG. 15, allowing the user to view and/or change the required spacing between panels in a row and/or between rows of panels. In the case of a flat roof or ground mount installation, the solar panels will be installed at some particular tilt angle, and as such, they will cast shadows.

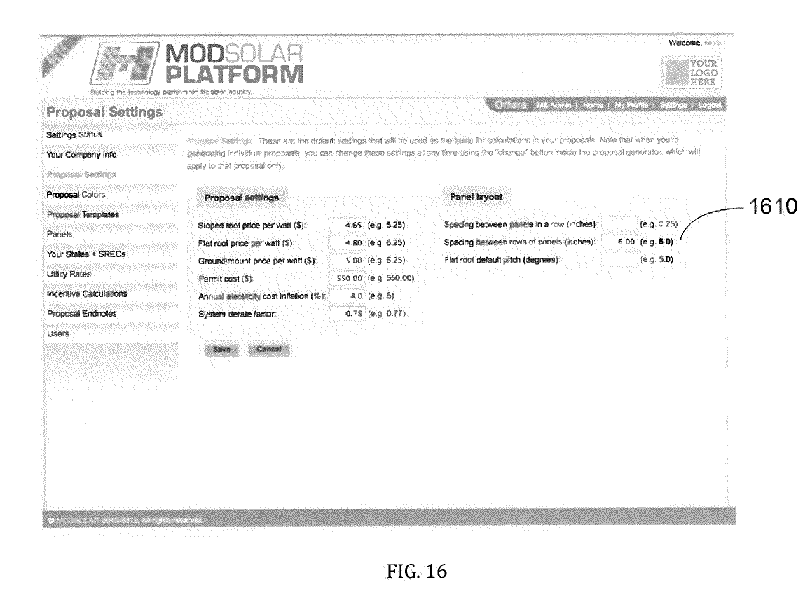

The above described capabilities of the user to alter the behavior of the interactive layout process controller as well as the individual algorithms, are not a requisite step in order for the application of the algorithms to commence. In the exemplary embodiment depicted in FIG. 4, when the user opts (430) to enter the layout step (100), the interactive layout process controller (11) immediately begins to asynchronously initiate the application of the appropriate algorithm(s) to achieve the layout goal(s). The user will see a screen such as the one exemplified in FIG. 6 once the panel layout results have been produced, ranked, and displayed. Only then does the user have the ability to alter the options (621, 622, 623) and initiate a re-run (630) of the algorithm(s). Thus, the interactive layout process controller necessarily has the ability to initiate the algorithm(s) using pre-defined values for the options, parameters, and constraints. Such pre-defined values can be defined in advance and maintained in a persistent data store, to be used as “default” values that the user can over-ride and then click the Re-run button (630). Certain pre-defined values can be globally defined as part of the embodiment of the invention, and loaded into volatile memory when the system that embodies the invention is started. Pre-defined values can also be configured by users or sub-classes of users, in order to establish the desired default values. In the exemplary embodiment, each member of a class of “administrator” users has the ability to configure certain pre-defined values for that user and other user associated with that user. FIG. 16 shows a screen from the exemplary embodiment, whereby an administrator can specify several options that impact the panel layout (1610).

Presentation of Results for Comparison

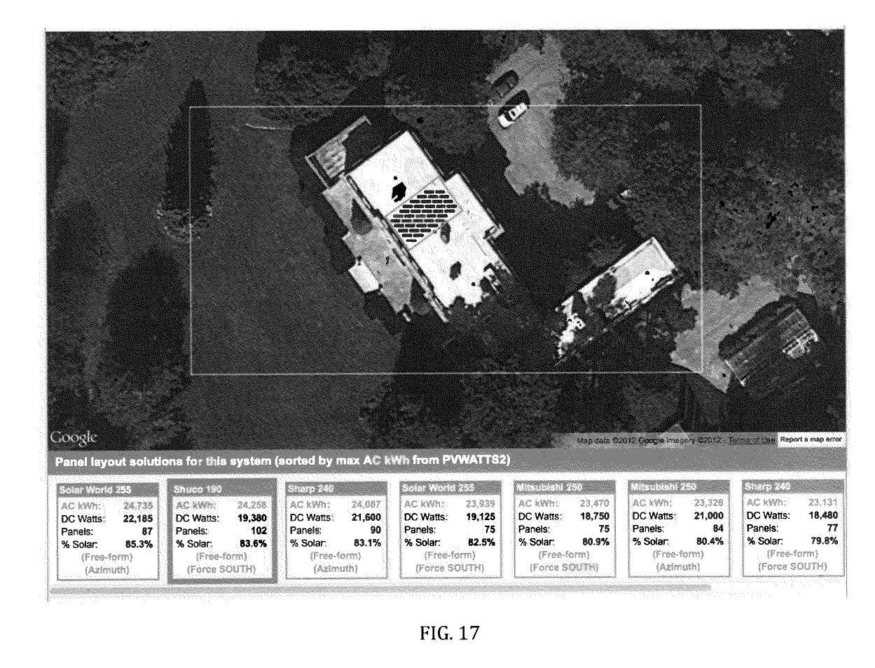

In FIG. 6, below the satellite imagery, the sorted list of panel layout solutions (640) appears, based on the ranking of generated layouts according to the goal(s). A heading over this area (641) reports the goal against which the layout solutions were ranked. Each solution includes the panel manufacturer/model designation (642) as well as relevant data (643) produced by the ranking process, providing the user with detailed information in order to make a selection. Finally, depending on the goal(s), it may be the case that multiple algorithms will be applied to the same panel manufacturer/model, and/or the same panel manufacturer/model may be run through an algorithm multiple times with different options, parameters, or constraints. To further distinguish the different panel solutions for the user's benefit, a label (644) will appear with each solution. In the scenario depicted in FIG. 6, each panel manufacturer/model was run through two different algorithms: one of which applied an edge-aligned (deterministic) layout approach, and the other which applied a free-form approach utilizing a genetic evolution simulation model. However, in the scenario depicted in FIG. 17, a single algorithm was applied to each panel manufacturer/model TWICE: once using the azimuth (the panel facing direction) specified by the user, and once using a due-south facing direction, ignoring the user's specified azimuth.

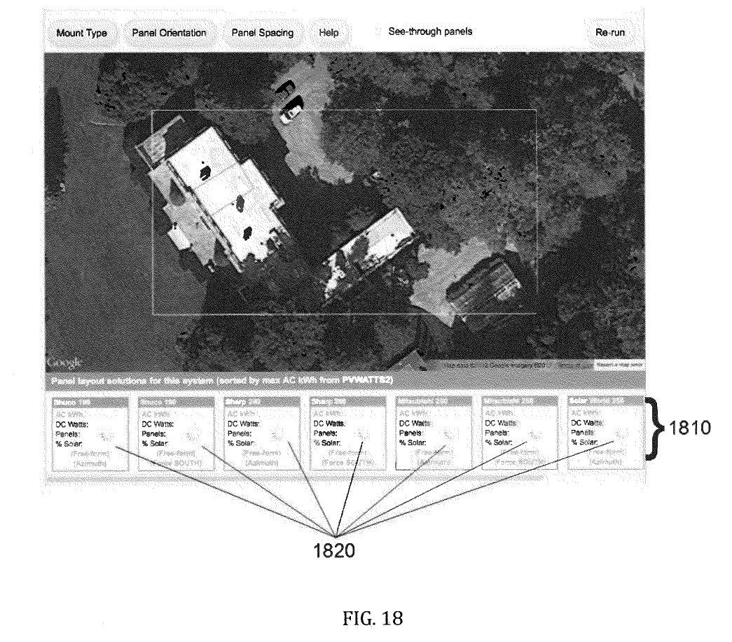

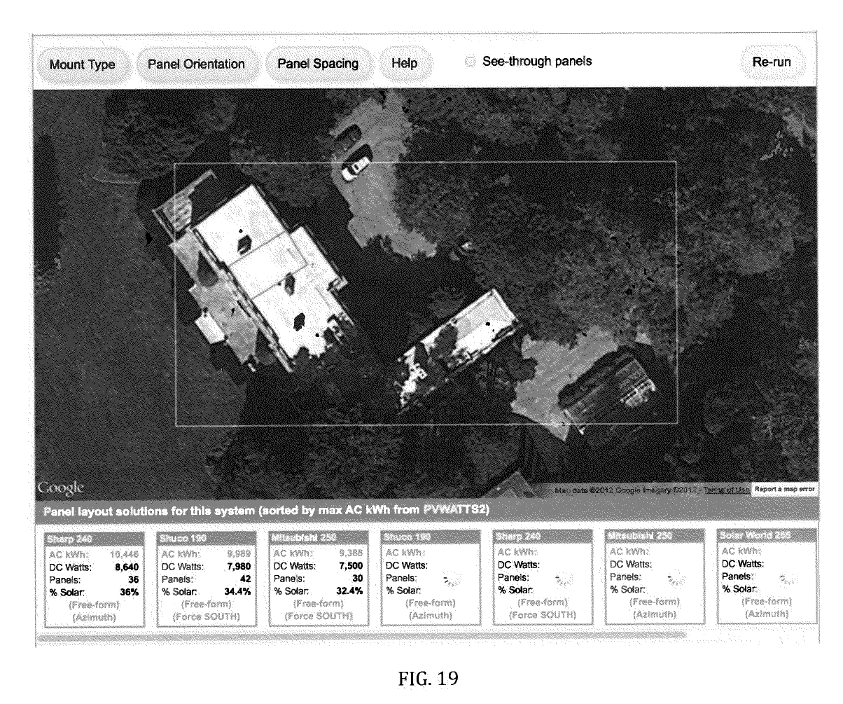

In the exemplary embodiment depicted in FIG. 4, when the user opts (430) to enter the layout step (100), the interactive layout process controller (11) presents a screen as exemplified in FIG. 18, and then immediately begins to asynchronously initiate the application of the appropriate algorithm(s) to achieve the layout goal(s). The area of the screen designated for panel layout solution results (1810) is pre-populated with the panel manufacturer/model designations, but the detailed information about the layout solutions are not shown; in their place, dynamic symbols are displayed (1820), that use continuous motion to signify that the algorithms are in process. Because the algorithms were initiated asynchronously, they will complete at varying times. As each algorithm completes, the resulting layout is ranked against the desired goal(s), and the dynamic symbol for that solution is replaced with the details of the solution. In addition, the list of solutions is resorted so that the “best” solution (according to the ranking) appears first (left-most) in the list. FIG. 19 illustrates the state of the layout screen after some (but not all) of the solutions have been returned by the algorithm sub-components.

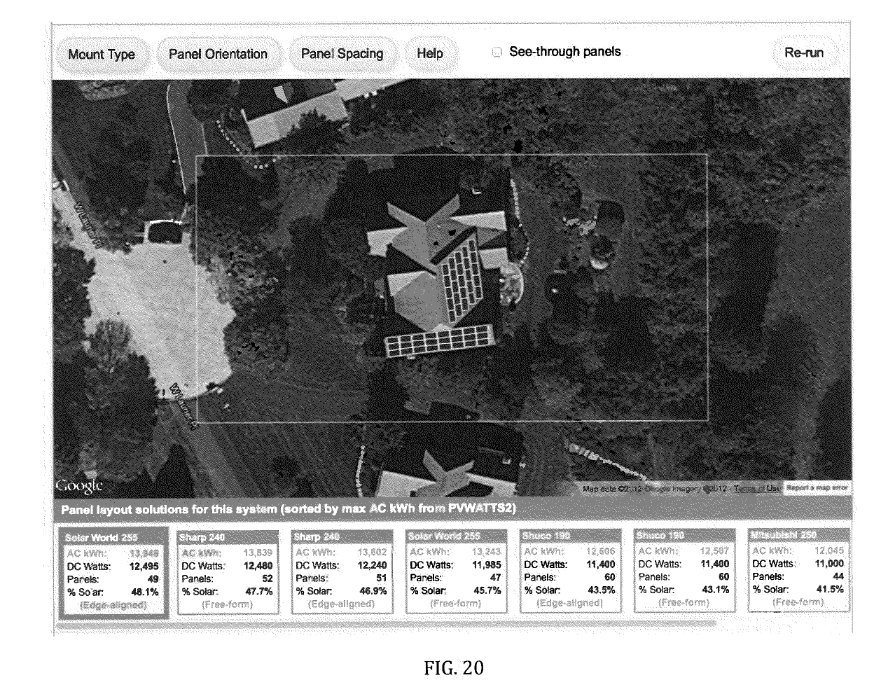

The user has the ability to click on any one of the panel solutions for which details have been displayed (indicating that the corresponding algorithm has completed, and has produced a layout solution). When the user clicks a solution, the corresponding layout is displayed, overlaid on the satellite imagery. FIGS. 20-22 illustrate the display of 3 different panel layout solutions within the same regions, having been the result of applying different algorithms with varying options and panel manufacturer/models, against the same designation panel placement regions.

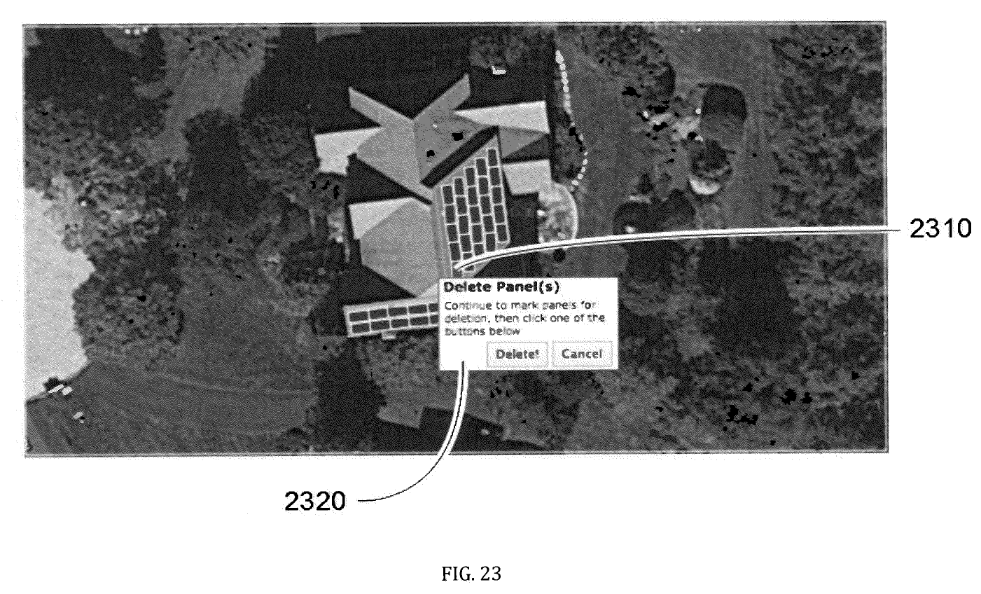

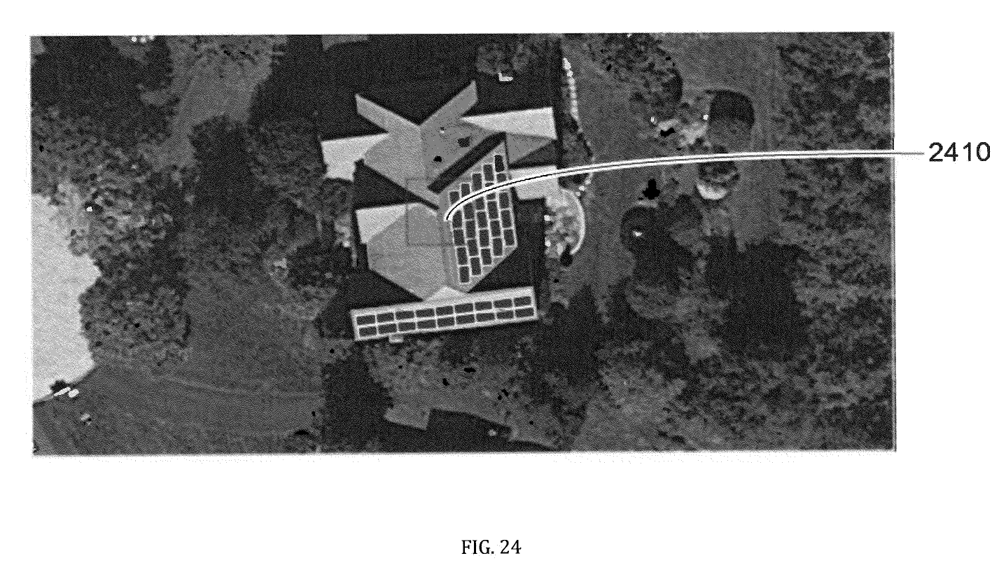

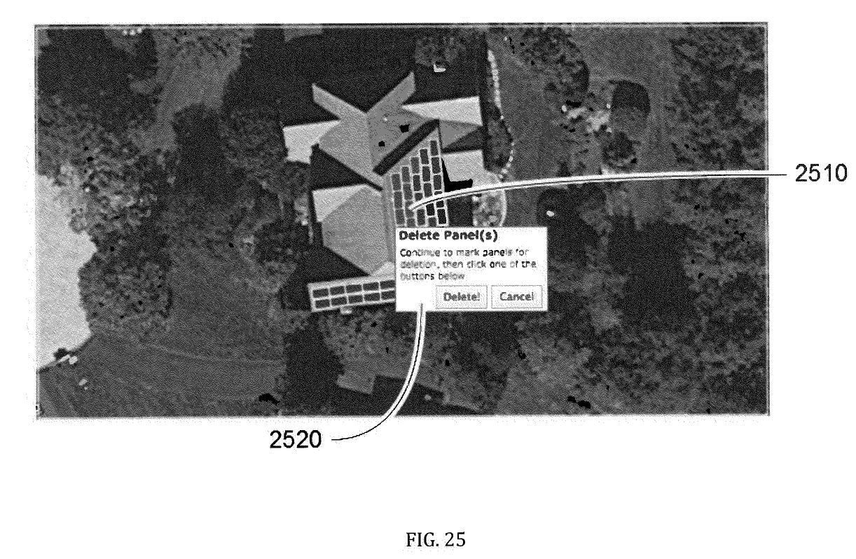

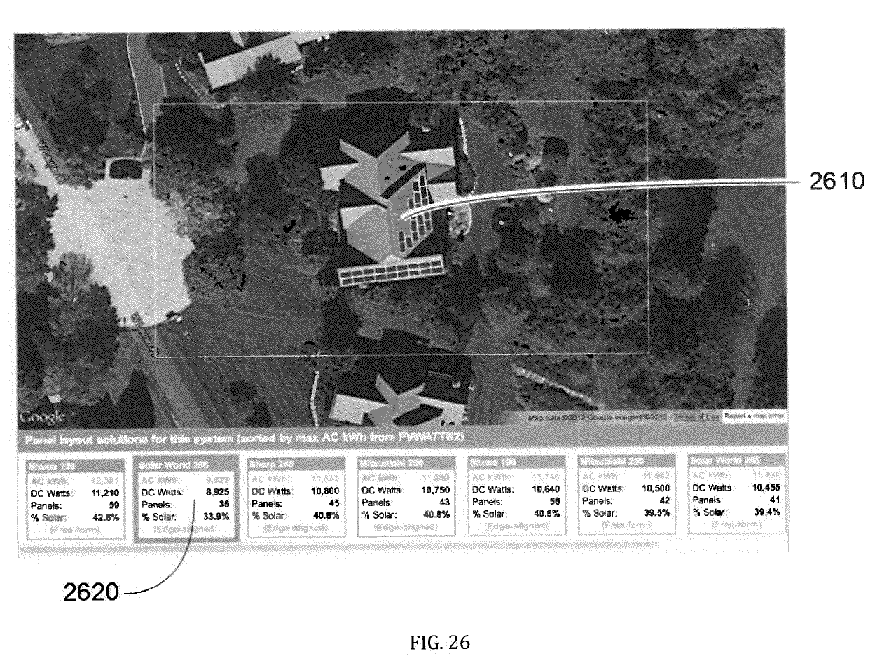

In the exemplary embodiment of the invention, the algorithms attempt to place panels within the designated region(s), but do not make allowances for possible physical obstructions within those regions—such as chimneys or air conditioning equipment on a roof Also in the exemplary embodiment of the invention, the algorithms do not impose margins or setbacks between the edges of the designated regions and the panels that are placed by the algorithms within those regions. Such capabilities may be included in the scope of the present invention, as additional options and input parameters to the algorithms. With or without those additional options, however, it is still desirable to give the user the ability to make manual adjustments to the layouts after they have been produced. Thus the user has the ability, when viewing the completed layout solutions, to delete individual panels and/or groups of panels. FIG. 23 illustrates the single panel deletion capability, in which the user has used the mouse or other pointing device to click on a single panel representation (2310) thus causing it to be displayed with a red fill color, and also causing the display of a prompt (2320) allowing the user to confirm or cancel deletion. FIG. 24 illustrates the multi-panel deletion capability (2410), in which the user has used the mouse or other pointing device to click somewhere within the satellite imagery, and has kept the pointing device's button depressed while moving the pointing device, resulting in a semi-transparent red rectangle overlaying some of the panels. In FIG. 25, the user has released the button on the pointing device (after having drawn the semi-transparent red rectangle, causing the panels that were contained within the rectangle or intersected by the borders of the rectangle to become candidates for deletion and filled with a red color (2510), as well as causing the delete confirmation prompt to appear (2520). FIG. 26 illustrates that, upon the user's confirmation of the deletion, the panels that were filled in red are removed from the display (2610), and the detail area in the corresponding solution reference (2620) is updated to reflect the reduction in panel count.

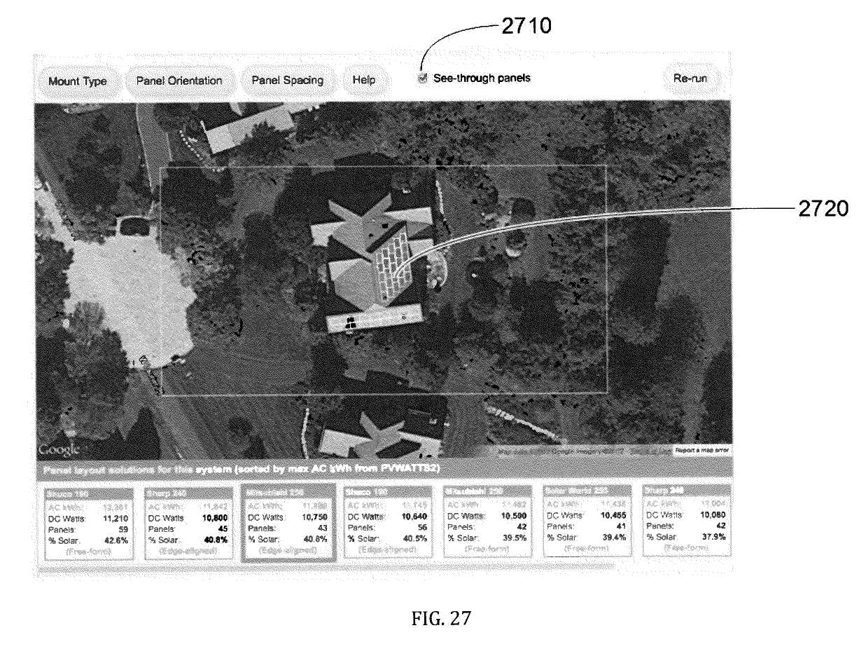

FIG. 27 illustrates the effect of clicking the checkbox labeled “See-through panels” (2710). In this mode, the panels are shown on the satellite imagery as rectangles, but with no interior fill, making it possible for the user to detect obstructions that might exist beneath the panels. This provides crucial information to the user, in order to decide which panels (if any) should be deleted from the layout.

Details of Exemplary Algorithms

In the exemplary embodiment of the invention, multiple mathematical approaches are used to determine the optimal panel layout for a given region, including a deterministic edge-aligned approach as well as a nondeterministic approach that employs a genetic evolution simulation model. Within the embodiment of the invention as described by FIG. 1, each of these approaches constitutes one of the possible plurality of algorithms (50).

As the invention is embodied with the exemplary system context of FIG. 4, it is one step (100) in an overall interactive process, providing the automated layout of panels in an optimal manner to achieve the desired goal(s). The user provides a street address (410) and visually inspects the location using overhead aerial or satellite imagery (420), and defines one or more roof regions or one or more areas on the ground (“roof mount” and “ground mount” respectively) (420).

A roof region can either correspond to a sloped roof (in which case it is assumed the panels are mounted flat on the roof) or a flat roof (in which case it is assumed the panels will be mounted at an angle with respect to the roof surface). A ground mount likewise assumes panels mounted at an angle. For the purposes of the exemplary algorithms described here, flat-roof mount and ground mount are equivalent.

Regardless of the mount type, one or more closed polygons are defined by the user (420) using a combination of Google Maps functionality and custom software tools detailed in FIG. 4. After closing each polygon the user specifies a directed azimuth line, and in the case of a sloped roof the pitch of the roof. For the case of ground/flat roof the azimuth line defines a vector that indicates a preferred orientation for laying out panels, for example, facing due south or parallel to a particular roof edge. For sloped roof installation the azimuth line is intended to indicate the direction of steepest descent on the roof (mathematically, the azimuth should be approximately parallel to the gradient of the roof elevation, and directed toward decreasing elevation). For sloped roofs the pitch is the minimal angle of the roof with respect to the horizontal. It is assumed that panels are installed in rows. The orientation of a panel with respect to the axis of a row can be portrait (currently defined as the long axis of the panel parallel to the row direction), or landscape (currently defined as the long axis of the panel perpendicular to the row direction). A single row is expected to include only portrait or only landscape panels; the orientations are not mixed within a single row.

The input to the algorithm consists of a collection of polygons, each initially specified as a collection of 3 or more latitude/longitude (“lat/lng”) coordinate pairs representing the vertices of the polygon, an orientation vector, roof pitch (used as needed), a specific manufacturer/model panel specified by long and narrow dimension, manufacturers' specifications for mount margins (if applicable), and any requirements as to inter-panel spacing (required gaps between panels along an installed row) and inter-row spacing.

Although inputs may be varied in ways that are independent of one another, certain practical considerations for real-world panel installation will necessarily dictate constraints on the inputs. For example, for flat roof and ground mount layouts, the panels will be mounted at a tilt angle relative to the ground. A steeper tilt angle results in the panels “standing taller,” and this can be a problem based on wind considerations at the installation site—and thus the height of the building might need to be considered by the user of the system, who has the ability to specify the input values. The panels' exposure to the sun—and therefore the resultant energy production—can be maximized if the panels are facing due south and the tilt angle is equivalent to the latitude (in degrees) where the panels will be installed (for installation locations in the northern hemisphere), but the resultant tilt angle might be impractical due to the wind considerations noted above. Regardless of the angle chosen, the panels in a row will cast shadows on the panels in the row behind them (relative to the position of the sun), and so the between-row spacing should be set with the inter-row shading considerations in mind. The algorithm has the ability to calculate inter-row shading mathematically, and thus calculate the necessary between-row spacing, as described below.

Two exemplary algorithms have been devised for automated layout of panels in a single roof region: in the case of the deterministic algorithm, layout lines are assumed to always lie parallel to one of the roof edges, in the case of the nondeterministic algorithm, a genetic algorithm is used to evolve a population of solutions for the panel layout. Both exemplary algorithms share certain key terminology. The terms and definitions are given below, followed by an explanation of each of the two algorithms.

Algorithm Terminology

The algorithm creates layout line objects, geometrical regions in which panels can be installed. Layout lines correspond to the installed rows of panels.

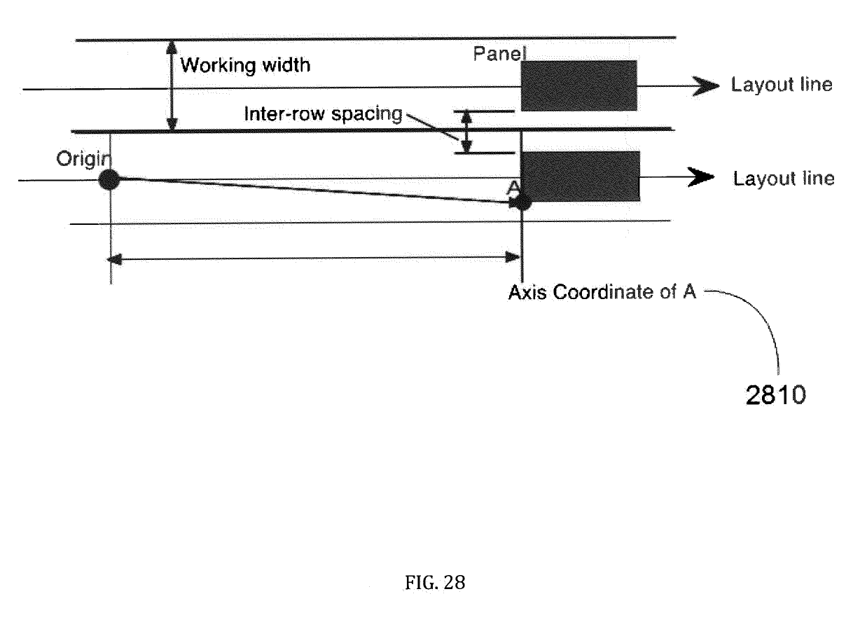

A layout line is defined by an origin (position vector), an axis (direction vector), and a working width (which defines the space perpendicular to the axis in which panels are accommodated, and which includes any requisite inter-row spacing). So, layout line objects are expected to touch at their edges, while still maintaining appropriate inter-row spacing. FIG. 28 illustrates. Note that any point in a layout line object is associated with an axis coordinate, equal to the projection along the axis vector of the displacement vector from the origin to the point. The axis coordinate is thus a real number, and can be negative, positive or zero. FIG. 28 illustrates the definition of the axis coordinate of a selected panel corner (2810).

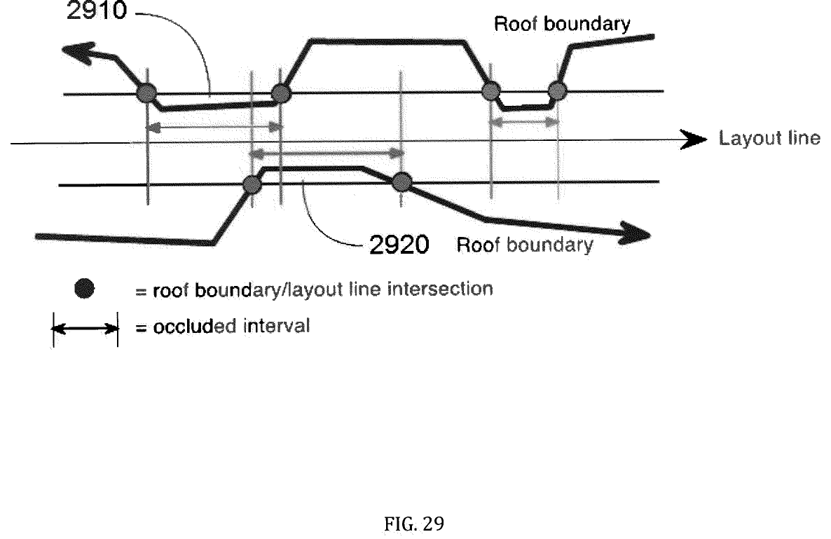

An isolated layout line object can contain an unlimited number of panels; it is the intersection between the layout line and the roof that introduces constraints and limits the number of panels included. A span is defined as an interval of axis coordinate along a layout line that can potentially accommodate panels. Spans are defined by occluded intervals, those segments along the layout line in which there is intrusion by the roof region polygon. Since the working width of a layout line object accommodates the width of the panel and any required margins and/or inter-row spacing, the edges of this object constitute a “hard” boundary, and any intrusion by the roof polygon excludes panels from being positioned anywhere within the occluded interval. FIG. 29 illustrates this terminology.

Note that occluded intervals are simply defined as closed numerical intervals along the layout axis coordinate, and that occluded intervals can potentially overlap (see the magenta (2910) and green (2920) intervals in FIG. 29).

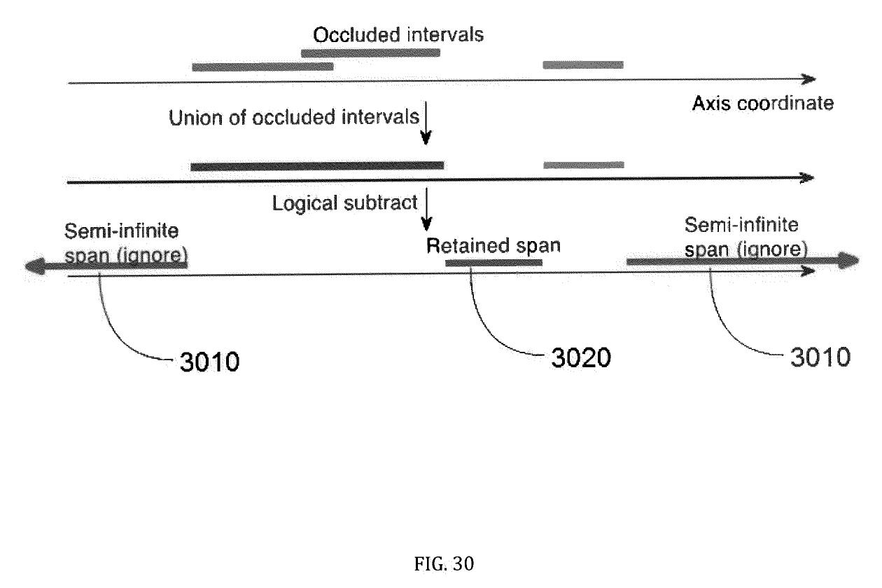

Spans are determined from occluded intervals by taking the logical union of the occluded intervals, followed by taking the logical difference of the real line (representing the entire layout line axis) minus the union of the occluded intervals. This process is illustrated in FIG. 30. This procedure always yields two semi-infinite open intervals (which are ignored) (3010) and a series of open intervals that are the spans (3020). For our purposes, the closure of these can be taken and we will treat the spans as closed intervals.

A span is productive if it is long enough to accommodate one or more panels and requisite inter-panel spacing. Nonproductive spans are ignored.

Deterministic (Edge-Aligned) Algorithm

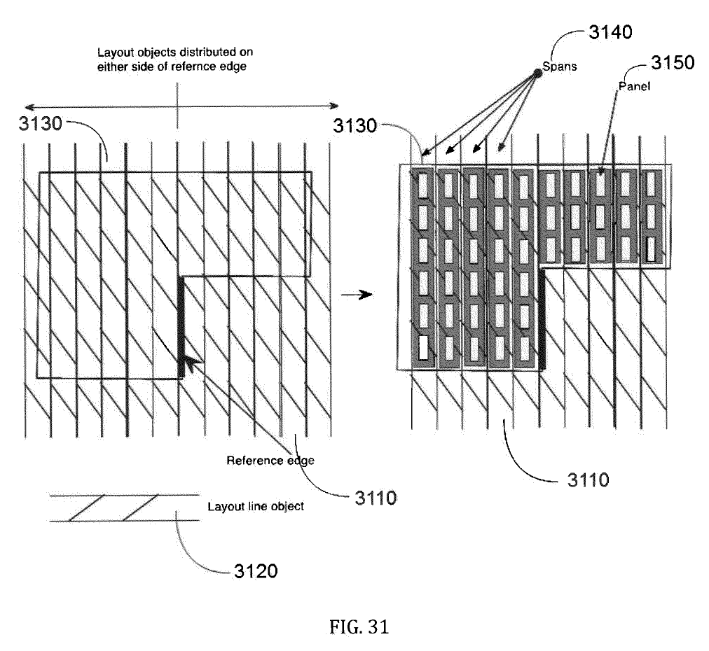

The deterministic algorithm, illustrated in FIG. 31, uses as reference an edge of the roof region (3110). Layout line objects (3120) are arranged in parallel to the starting edge, and arranged on either side of the starting edge. Propagation of layout line objects on a given side of the edge terminates when a layout line object lies completely outside the roof region (this is determined using a simple geometric test). For each layout line object, occluded intervals are computed given the roof edges, and productive spans determined from the occluded intervals. Each productive span is filled with the maximal number of panels it will contain, and the total number of panels is computed for all the layout lines. A goal of the deterministic solution is that it be calculated quickly, so all layout line objects correspond to either portrait or landscape orientation.

A given edge, plus a selected panel orientation, thus determines a pattern of layout line objects, which together define a single layout. A layout (together with the roof geometry) defines an arrangement of panels, and their total number.

This procedure is repeated for each roof edge (except “short” edges, <¼ the length of the longest roof edge), and the corresponding layout with maximal panels is retained, for a given panel orientation. Depending on a setting selected by the user, the maximal layout will be returned with orientation constrained to either portrait or landscape, or the best solution found using either option will be returned. FIG. 31 illustrates the deterministic layout approach. In this figure, the five-sided polygon (3130) represents a roof region, and the current reference edge (3110) is highlighted. Layout line objects (3120), spans (3140) and panels (3150) are shown in the drawing. The arrangement of panels for a particular reference edge is a layout. In this case the panels are constrained to adopt portrait orientation (long axis of panel parallel to layout line direction).

Non-Deterministic (“Genetic”) Algorithm

The non-deterministic approach is more flexible and potentially more powerful, in the sense of being able to approach (or even realize) a truly optimal solution. The algorithm employs a simulation of biological genetic evolution, to “grow” the optimal layout after a series of generation.

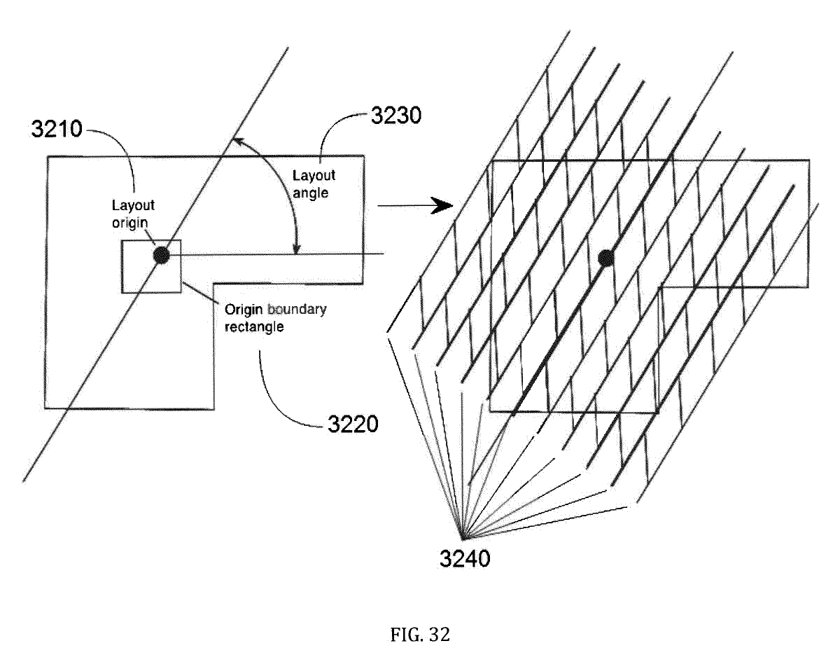

The non-deterministic algorithm uses the same fundamental elements as illustrated in FIG. 31, with one key difference—rather than aligning the layout with a roof edge, the origin of layout and the angle of the layout line objects are adjustable parameters. The origin and angle define a line, which serves the same role as the selected roof edge in the deterministic algorithm. FIG. 32 illustrates the geometry of the non-deterministic algorithm.

To construct an “optimal” layout in this scenario, we generate a population of solutions using the Genetic Algorithm method. The Genetic Algorithm method is part of the evolutionary computing area of artificial intelligence. The Genetic Algorithm applies concepts of the evolution of populations of biological organism (genes, chromosomes, mating, crossover, mutation, fitness, etc.) to abstract and real-world problems. The present invention operates the Genetic Algorithm in the system using an open source software package Java Genetics Algorithm Package (JGAP) available by Sourceforge.net® at jgap.sourceforge.net.

In order to appreciate the compatibility of the Genetic Algorithm with the present invention, a brief explanation of genetic evolution with its tantamount variables and potential for outcomes is provided. In this respect, each specific physical trait of any biological organism is encoded in a gene. Each gene has a setting that indicates the corresponding trait. For example, the hair color gene's settings might be blonde, black, or auburn; the eye color gene's settings might be blue, black, or hazel, etc. The genes of an organism are connected into long strings (in a specific sequence) called chromosomes and those chromosomes exist in every cell of the organism. A particular collection of genes and their settings are referred to as the organism's genotype. The physical expression of that genotype—the organism itself and its observable traits—is called a phenotype.

An offspring of two organisms will have traits inherited from its parent organisms. The genotype of the offspring will consist of a combination of genes from each of the parents. The number of genes from each parent (50%/50%, 75%/25%, etc.) can vary (if they did not, all siblings—even those born years apart—would have the exact same traits!). The process by which chromosomes mate is known as recombination. Basically, the recombination process selects a gene from each parent, to produce a new chromosome that mixes the parents' genes. For each position in the chromosome, the corresponding gene from that position in either one parent or the other parent is used, thus forming a new sequence of genes (a new chromosome). In very rare cases, during the recombination process, a mutation might occur—basically, when the gene is copied from the parent to form the chromosome of the offspring, that gene is somehow transformed. Occasionally, such a mutation may impact the development of the phenotype—the organism will have a brand new trait.

When a mutation occurs that results in an organism having a brand new trait, that organism might, as a result, have a higher probability of survival in its native environment—the trait increases the organism's fitness. As a result, there will be a greater probability that this particular organism will produce offspring, and will have an opportunity to pass this new trait on to its offspring. Over many, many generations, such traits that increase the fitness of the organism will become more prevalent, until the vast majority of the population exhibits the trait. Over a span of many generations, with many different recombinations producing offspring at each generation with different combinations of traits, and with occasional mutations, the environment will produce an organism with a higher level of fitness, through a process of natural selection.

The Genetic Algorithm applies all of these concepts to abstract and real-world problems. In order to find the optimal solution to a problem, genes are defined to represent the variables that might be adjusted when attempting to solve a problem. An initial population of chromosomes is created, where each chromosome consists of a collection of particular values of the defined genes. The chromosomes are scored for fitness—how well they solve the problem at hand—and those with a higher level of fitness are selected and paired off to produce offspring. A typical application of the approach will produce two offspring in the succeeding generation from each pair of chromosomes chosen for mating in the present generation (thus keeping the population size constant from one generation to the next, though its overall fitness—how well it solves the problem—will gradually evolve). This is accomplished by choosing a single random crossover point in the sequence of genes. One of the offspring receives all genes prior to that point from the first parent, and after that point from the second parent. The other offspring receives the converse: all genes prior to the crossover point from the SECOND parent, and after the crossover point from the FIRST parent. Depending on how the problem's variables have been encoded as genes, it may or may not be necessary to use mutations in the implementation of the algorithm (it may be sufficient to simply evolve an optimal solution as the best combination of genes).

In practice, the Genetic Algorithm approach has been shown to produce solutions that are close to, or even match, theoretical optimal solutions.

The Genetic Algorithm within the exemplary embodiment is applied based on the geometry illustrated in FIG. 32. Each member of the population (each chromosome) is defined using a set of genes that specify: (i) Two-dimensional position of the layout origin (3210)—this is selected from a rectangle (3220) near the geometric center of the roof region; (ii) Angle of the layout direction (3230)—selected from the range [−180°,180°] with respect to the horizontal; and (iii) a set of portrait/landscape flags, equal in number to the maximum number of layout line objects (3240) possible—this is set by making a generous estimate given the enclosing radius of the roof region and the (narrower) working width of the portrait orientation. This maximum number is used for all chromosomes in the population in the simulation. Each flag controls the orientation of panels in the associated layout line object (once spans are generated).

Thus, if the estimated maximum number of layout line objects is 20, each “chromosome” will comprise 23 genes (2 for the x/y position of the origin, 1 for the layout angle, 20 for portrait/landscape flags).

The Genetic Algorithm is initiated by generating an initial population of chromosomes; the length of the chromosomes is determined from the roof or ground region geometry (which implies maximum number of layout lines), the number of chromosomes is a configurable parameter in the exemplary embodiment; the larger the population, the greater the likelihood of identifying a truly optimal solution (and the greater the compute time). The genes of the initial population are set at random. It should be noted that while the non-deterministic algorithm permits maximal flexibility (i.e. any mix of layout lines with portrait or landscape orientation, and any layout angle), it is possible to introduce some constraints: (i) Layout angle can be constrained to be perpendicular to the roof orientation vector (this vector can thus serve as a “handle” to define the orientation of rows), OR to be perpendicular to due south (so that panels in all rows have optimal orientation toward the sun); (ii) Panel orientation can be constrained to portrait or landscape (effectively, all portrait/landscape flag genes are constrained to a single value); and (iii) A grid constraint can be imposed, so that the corners of panels in each row are aligned with panel corners in adjacent rows.

Once the initial population is defined, each chromosome is “scored.” In our case, the chromosome defines a specific layout in the roof region, and the score is simply the number of panels. A larger score implies a “fitter” chromosome (in analogy to biological evolution).

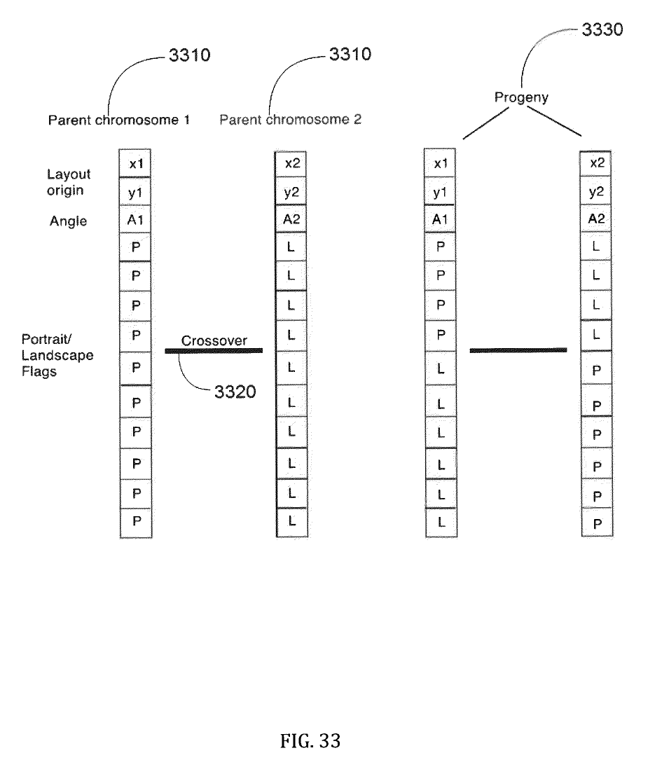

Next the population is evolved. Chromosomes are selected for “mating” to produce progeny chromosomes for the next generation, based on their fitness. Those with higher fitness scores have a higher probability of being selected for mating (FIG. 33). Two chromosomes (3310) mate; a “crossover” point (3320) is selected at random, and genetic material is exchanged between the two parents, yielding two child chromosomes (3330) that blend the traits of the parents. (In FIG. 33, a “portrait-only” solution and a “landscape-only” solution produce a pair of progeny that mix portrait and landscape orientations.) Mating events are carried out until the population of child chromosomes has the requisite size (equal to the starting population).

The entire process is then iterated: the second-generation chromosomes are scored, and mated to produce a third generation, and so on. The process is continued for a fixed number of generations. In the exemplary embodiment the population size and number of generations are among the pre-defined values that are globally defined as part of the embodiment of the invention, and loaded into volatile memory when the system that embodies the invention is started. The population size is typically several hundred, and the number of generations ranges from 50 to 1,000.

While the invention has been described above in conjunction with specific embodiments, it is evident that many alternatives, modifications, permutations, and variations will become apparent to those skilled in the art in light of the foregoing description. Accordingly, it is intended that the present invention embraces all such alternatives, modifications, and variations as fall within the scope of the claims below.

What is claimed is:

1. A data processing system for layout automation of a solar panel array, the system comprising:
an interactive layout process controller which receives multiple data inputs comprising parameter values and physical constraints for solar panels at an installation site for the solar panel array, aerial imagery of the installation site, and solar panel performance data;
a database management system for functioning as a storage repository for persistent data;
wherein the interactive layout process controller processes the multiple data inputs with a layout algorithm to develop one or more layout schemes for the solar panels to meet installation goals for the solar panel array, then calculates energy production for the layout schemes, and then scores the layout schemes against the installation goals; and
wherein the interactive layout process controller displays the layout schemes for the solar panels overlaid on the aerial imagery and the scores for the layout schemes to permit an end-user of the system to compare the layout schemes and the scores and to select a layout scheme.

2. The data processing system of claim 1 wherein the aerial imagery of the installation site is received from a first web service interface or the data management system.

3. The data processing system of claim 2 wherein the first web service interface comprises Google Maps.

4. The data processing system of claim 1 wherein the layout schemes are developed by interactive use of the aerial imagery by the end-user.

5. The data processing system of claim 4 wherein the interactive use comprises drawing on the aerial imagery.

6. The data processing system of claim 1 wherein the installation goals comprise maximization of energy production from the solar panels according to an optimized layout scheme, achievement of cost range for the solar panel array, achievement of a size range for the solar panel array, minimization of layout hardware for the solar panel array, or a combination of any one or more thereof.

7. The data processing system of claim 1 wherein the energy production is calculated using a second web service interface or data stored in the data management system.

8. The data processing system of claim 7 wherein the second web service interface is the U.S. Government PV Watts web service interface.

9. The data processing system of claim 1 wherein the solar panel array is intended to be installed on any one or more of a sloped roof, a flat roof, or a ground location.

10. The data processing system of claim 1 wherein the multiple data inputs also comprise at least one or more of data comprising a direction that the solar panels should face, roof slope angle, solar panel tilt angle, geographic latitude of the installation site, geographic longitude of the installation site, between-panel spacing, between-row spacing of the solar panels, and panel orientation comprising portrait, landscape or a combination of both.

11. The data processing system of claim 10 wherein the end-user may specify at least one or more of the multiple data inputs comprising the direction that the solar panels should face, the between-panel spacing, the between-row spacing, the panel orientation, the roof slope angle, and the solar panel tilt angle.

12. The data processing system of claim 10 wherein values of the geographic latitude and the geographic longitude of the installation site are used to automatically set the solar panel tilt angle in the system.

13. The data processing system of claim 10 wherein values of the between-row spacing are automatically set in the system.

14. The data processing system of claim 1 wherein the layout algorithm is directed to produce layout schemes in a grid pattern with rows and columns of the solar panels in alignment.

15. The data processing system of claim 1 wherein parameters that control function of the layout algorithms can be specified at system start time.

16. The data processing system of claim 1 wherein parameters that control function of the layout algorithms can be specified in advance as default values, and used whenever the layout algorithms are applied, unless the end-user chooses to override individual parameters.

17. The data processing system of claim 1 wherein the layout algorithm is selected from a deterministic edge-aligned approach or a non-deterministic approach implementing genetic evolution simulation.

18. The data processing system of claim 17 wherein parameters that control population size variables and number of generational iterations of the genetic evolution simulation in the non-deterministic approach can be specified by configuration options at system start time.

19. The data processing system of claim 1 wherein the layout schemes produced by the layout algorithm are displayed to the end-user in a format that permits comparison of layout details.

20. The data processing system of claim 19 wherein the end-user can view a simulated solar panel array of each layout scheme overlaid on the aerial imagery.

21. The data processing system of claim 20 wherein the end-user can delete one or more solar panels from the simulated solar panel array of the layout scheme.

22. A method for automated layout of solar panels in an array, the method comprising:
inputting site data into an interactive layout process controller, the site data comprising information about an installation site, installation goals for the array, and parameter values and physical constraints for the solar panels at the installation site;
receiving performance data in the interactive layout process controller, the performance data comprising aerial imagery of the installation site, solar panel specification data, and solar panel energy production data;
applying a layout algorithm to the site data and the performance data to develop layout schemes for the array at the installation site;
calculating energy production for the layout schemes and scoring the layout schemes against the installation goals for the array; and
displaying one or more solar panel layout schemes overlaid on the aerial imagery for the installation site.

23. The method of claim 22 wherein the method comprises receiving the aerial imagery of the installation site from a first web service interface or a data management system.

24. The method of claim 23 wherein the first web service interface comprises Google Maps.

25. The method of claim 22 wherein the method comprises developing the layout schemes by interactive use of the aerial imagery by an end user.

26. The method of claim 25 wherein the interactive use comprises drawing on the aerial imagery.

27. The method of claim 22 wherein the installation goals for the array comprise maximizing energy production from the solar panels according to an optimized layout scheme, meeting a cost range for the solar panel array, achieving a size range for the solar panel array, minimizing layout hardware for the solar panel array, or a combination of any one or more thereof.

28. The method of claim 22 wherein the step of calculating energy production for the layout schemes comprises using energy production data retrieved from a second web service interface or from a data management system.

29. The method of claim 28 wherein the second web service interface is the U.S. Government PV Watts web service interface.

30. The method of claim 22 wherein the array is intended to be installed on any one or more of a sloped roof, a flat roof, or a ground location.

31. The method of claim 22 wherein the site data also comprise at least one or more of data comprising a direction that the solar panels should face, roof slope angle, solar panel tilt angle, geographic latitude of the installation site, geographic longitude of the installation site, between-panel spacing of the solar panels, between-row spacing of the solar panels, and panel orientation comprising portrait, landscape or a combination of both.

32. The method of claim 31 wherein the step of inputting site data into the interactive layout process controller comprises specifying at least one or more of the site data comprising the direction that the solar panels should face, the between-panel spacing, the between-row spacing, the panel orientation, the roof slope angle, and the solar panel tilt angle.

33. The method of claim 31 wherein the step of applying the layout algorithm to the site data comprises automatically setting values of the solar panel tilt angle based on the geographic latitude and geographic longitude of the installation site.

34. The method of claim 31 wherein the step of applying the layout algorithm to the site data comprises automatically setting values of the between-row spacing of the solar panels.

35. The method of claim 22 wherein the step of applying the layout algorithm comprises directing the algorithm to produce layout schemes in a grid pattern with rows and columns of the solar panels in alignment.

36. The method of claim 22 wherein the step of applying the layout algorithm comprises specifying parameters that control the function of the layout algorithms at a start time.

37. The method of claim 22 wherein the step of applying the layout algorithm comprises specifying parameters that control a function of the layout algorithm in advance as default values, and using the parameters whenever the layout algorithms are applied, unless individual parameters are overridden.

38. The method of claim 22 wherein the layout algorithm comprises a deterministic edge-aligned approach or a non-deterministic approach implementing genetic evolution simulation.

39. The method of claim 38 wherein the step of applying the layout algorithm in the non-deterministic approach comprises specifying the parameters that control population size variables and number of generational iterations of the genetic evolution simulation using configuration options at a start time.

40. The method of claim 22 wherein the step of displaying one or more solar panel layout schemes comprises presenting the layout schemes produced by the layout algorithm in a format that permits comparison of layout details.

41. The method of claim 40 wherein the step of displaying one or more solar panel layout schemes comprises overlaying a simulated solar panel array of each layout scheme on the aerial imagery.

42. The method of claim 41 wherein the method comprises the further step of deleting one or more solar panels from the simulated solar panel array of the layout scheme.

43. A computer readable medium encoded with instructions for a program configured for execution by an interactive layout process controller to perform a method for automating layout of solar panels in an array at an installation site, the program comprising:
receiving multiple data inputs comprising data about the installation site, aerial imagery of the installation site, solar panel performance data, installation goals for the installation site, and parameter values and physical constraints for the array at the installation site;
developing solar panel layout schemes for the installation site using a layout algorithm;
calculating energy production for the panel layout schemes and scoring the layout schemes against the installation goals, and
displaying the layout schemes overlaid on the aerial imagery with the scores.
